(19) United States
(12) Patent Application Publication
(10) Pub. No.: US 2005/0046689 A1
(43) Pub. Date: Mar. 3, 2005

(54) Optical disk medium, optical disk medium production method, turntable and optical disk apparatus

(76) Inventors: Takakiyo Kanazawa, Kanagawa (JP); Takahiro Miura, Kanagawa (JP); Hidetoshi Watanabe, Chiba (JP)

Correspondence Address: JAY H. MAIOLI;Cooper & Dunham LLP, 1185 Avenue of the Americas, New York, NY, 10036, US

(21) Appl. No.: 10/912,390

(22) Filed: Aug. 5, 2004

(30) Foreign Application Priority Data
Aug. 11, 2003 (JP) P2003-291170
Aug. 11, 2003 (JP) P2003-291171
Aug. 14, 2003 (JP) P2003-293328

(51) Int. Cl. B41J 2/385

(52) U.S. Cl. 347/153; 347/221

(57) ABSTRACT

An optical disk that is prevented from being warped when it is driven to rotate by a turntable includes a disk substrate formed as a metal substrate made of a magnetic substance. When the optical disk is mounted on a disk receiving face of the turntable, the metal substrate is attracted to the disk receiving face of the turntable by the magnetic force, thereby to correct any warping of the optical disk medium with a high degree of accuracy.

### BACKGROUND OF THE INVENTION

This invention relates to an optical disk medium on and/or from which data is recorded and/or reproduced by an optical system or a magneto-optical system, a turntable for driving the optical disk to rotate, and an optical disk apparatus wherein data is recorded on and/or reproduced from the optical disk medium by means of an optical pickup while the turntable is driven by a spindle motor to rotate the optical disk medium.

The present invention relates also to a method of producing an optical disk on and/or from which data is recorded and/or reproduced by an optical system or a magneto-optical system.

An optical disk medium such as an optical disk or a magneto-optical disk on and/or from which data is recorded and/or reproduced by an optical system or a magneto-optical system includes a data recording layer of optical pits, a magnetic film or the like formed on one or both of the opposite faces of a disk substrate and a transparent protective film coated as an overlying layer of the data recording layer as well known in the art. The optical disk medium is usually fitted and chucked at a center hole thereof with and by an outer periphery of a centering projection on a turntable and driven to rotate by the turntable while data is recorded and/or reproduced on and/or from the data recording layer using a light beam or magneto-optically.

Various optical disk media of the type described are conventionally known including an optical disk medium wherein a metal substrate is used as a disk substrate (refer to, for example, Patent Document 1) and another optical disk medium wherein, in place of a center hole formed in a disk substrate, a center hole of a metal hub attached to a lower face at a central portion of the disk substrate is used to fit with and chucked by a spindle at the center of a turntable so that the disk is driven to rotate by the turntable (refer to, for example, Patent Document 2). Also an optical disk medium is known wherein an annular (doughnut-shaped) printed label is pasted from above and below to a portion between inner side portions of data recording regions at outer side portions with respect to a center hole of two upper and lower one-sided optical disks (refer to, for example, Patent Document 3).

Meanwhile, in a magnetic disk on and/or from which data is recorded and/or reproduced by means of a magnetic head, a metal substrate is normally used as a disk substrate, and a magnetic film is formed on the surface of the metal substrate. The magnetic disk is usually produced by injecting molten metal material of magnesium alloy or the like into a cavity of a metal mold and allowing the metal material to cure thereby to injection mold one by one metal substrate, punching out a center hole at the center of the metal substrate by means of a punch and then forming a thin magnetic film on the surface (on one face or the opposite faces) of the metal substrate by sputtering or the like (refer to, for example, Patent Document 4).
[Patent Document 1] Japanese Patent Laid-Open No. Hei 11-345412
[Patent Document 2] Japanese Patent Laid-Open No. Hei 07-225972
[Patent Document 3] Japanese Patent Laid-Open No. Hei 08-297867
[Patent Document 4] Japanese Patent Laid-Open No. Hei 11-345412 (Japanese Patent Application No. 2003-293328)

Any of such conventional optical disk media as described above is disadvantageous in that, when it is driven to rotate by a turntable to record and/or reproduce data on and/or from the optical disk medium by means of an optical pickup, if the optical disk medium has some warping, then out-of-plane deflections occur therewith upon rotation thereof and give rise to a focusing error or a tracking error. Consequently, high density recording/reproduction cannot be anticipated.

Further, a region of a conventional optical disk medium in which a picture, a character or the like is displayed or a data recording region is limited to a small region of a portion of the optical disk medium between an outer side portion of a center hole and a data recording region.

Further, with the conventional optical disk medium production method described above, since a magnetic disk or the like is produced one by one, the production or manufacture efficiency is very low and a high production cost is required. Further, where an optical disk medium has a center hole formed in a metal substrate, the region of a data recording region or a region in which a picture, a character or the like is to be displayed is restricted.

### SUMMARY OF THE INVENTION

It is an object of the present invention to provide an optical disk medium, a turntable, and an optical disk apparatus wherein warping of the optical disk medium is eliminated to achieve high density recording/reproduction.

It is another object of the present invention to provide an optical disk medium wherein a wide region can be used as a data recording region or a region for displaying a picture, a character or the like.

It is a further object of the present invention to provide an optical disk medium production method by which a plurality of optical disk media can be produced at a time to achieve a high production efficiency and reduction in production cost.

In order to attain the objects described above, according to an aspect of the present invention, there is provided an optical disk medium, including a metal substrate being made of a magnetic substance and forming a disk for correcting the flatness of the optical medium disk.

According to another aspect of the present invention, there is provided an optical disk medium, including: a metal substrate being made of a magnetic substance and forming a disk for correcting the flatness of the optical medium disk; a data recording layer; and a picture-character layer formed on one or both of the opposite faces of said metal substrate and drawn or printed a picture, a character, or the like which can be visually observed through the data recording layer.

According to another aspect of the present invention, there is provided a turntable having a disk receiving face for receiving an optical disk medium, the optical disk medium including a metal substrate forming a disk for correcting the flatness of the disk and made of a magnetic substance, the turntable magnetically attracting the optical disk medium to the disk receiving face.

According to a further aspect of the present invention, there is provided an optical disk apparatus, including a turntable having a disk receiving face for receiving an optical disk medium, the optical disk medium including a metal substrate forming a disk for correcting the flatness of the disk and made of a magnetic substance, the turntable magnetically attracting the optical disk medium to the disk receiving face, a spindle motor for driving the turntable to rotate, and an optical pickup for recording and/or reproducing data on and/or from the optical disk medium being rotated by the turntable.

With the optical disk medium, turntable, and optical disk apparatus, since the optical disk medium includes a metal substrate made of a magnetic substance, when it is mounted on the disk receiving face of the turntable, it can be attracted to the disk receiving face by the magnetic force to correct any warping of the optical disk medium with a high degree of accuracy. Consequently, out-of-plane deflections of the optical disk medium upon rotation for recording and/or reproduction of data can be suppressed to a low level. Therefore, there is an advantage that a focusing error is not likely to occur and high density recording and/or reproduction can be anticipated.

According to a still further aspect of the present invention, there is provided an optical disk medium, including a disk having no center hole, and a picture-character layer formed in a wide area from an outer periphery to a portion within a radius of 0.5 mm to the center of the disk and drawn or printed a picture, a character, or the like, or a data recording layer formed in a wide area from an outer periphery to a portion within a radius of 0.5 mm to the center of the disk, or else a data recording layer formed in a wide area from an outer periphery to a portion within a radius of 0.5 mm to the center of the disk and a printed layer formed in a wide area from an outer periphery to a portion within a radius of 0.5 mm to the center of the disk and drawn or printed a picture, a character, or the like in such a manner as to be visually observed through the data recording layer.

According to a yet further aspect of the present invention, there is provided a turntable having a disk receiving face for receiving such an optical disk medium as described just above, the turntable further having a disk positioning rib formed along an outer periphery of the disk receiving face.

According to a yet further aspect of the present invention, there is provided an optical disk apparatus, including such a turntable described above as described just above, a spindle motor for driving the turntable to rotate, and an optical pickup for recording and/or reproducing data on and/or from the optical disk medium being rotated by the turntable.

With the optical disk medium, turntable and optical disk apparatus, the disk has no center hole, and a picture-character layer drawn or printed a picture, a character, or the like or a data recording layer can be formed in the wide area from the outer periphery to the portion within the radius of 0.5 mm to the center of the disk. Consequently, there is an advantage that an advertising effect and improvement in fine appearance by an increased area of the picture-character layer or implementation of a large capacity disk by an increased area of the data recording layer can be achieved.

According to an additional object of the present invention, there is provided an optical disk medium production method for producing an optical disk medium wherein a data recording layer, a reflecting film, and a protective film are layered on at least one face of a metal substrate, including the steps of layering a data recording layer, a reflecting film, and a projective film at each of a plurality of locations of at least one face of a large-size metal substrate to form a plurality of small-size optical disk media at a time, and punching out the small-size optical disk media at a time from the large-size metal substrate.

According to another additional object of the present invention, there is provided an optical disk medium production method for producing an optical disk medium wherein a picture-character layer on which a picture, a character, or the like is drawn or printed, a data recording layer, a reflecting film, and a protective film are layered on at least one face of a metal substrate, including the steps of layering a picture-character layer, a data recording layer, a reflecting film, and a projective film at each of a plurality of locations of at least one face of a large-size metal substrate to form a plurality of small-size optical disk media at a time, and punching out the small-size optical disk media at a time from the large-size metal substrate.

With the optical disk medium production methods, since a plurality of small-size optical disk media can be produced at a time from a single large-size metal substrate, the production or manufacture efficiency of optical disk media is improved significantly and significant reduction of the production cost for optical disk media can be achieved.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a side elevational view, partly in section, showing part of an optical disk apparatus to which the present invention is applied;

FIGS. 2A and 2B are a schematic plan view and a schematic side elevational view, respectively, showing an entire optical disk medium to which the present invention is applied;

FIG. 3 is an enlarged schematic sectional view showing part of the optical disk medium of FIGS. 2A and 2B where the optical disk medium is applied to a one-sided disk;

FIG. 4 is an enlarged schematic sectional view showing part of the optical disk medium of FIGS. 2A and 2B where the optical disk medium is applied to a two-sided disk;

FIG. 5 is an enlarged schematic sectional view showing part of the optical disk medium of FIGS. 2A and 2B and illustrating that unnecessary reflected light from a picture-character layer does not mix into necessary reflected light by setting the thickness of a data recording layer of the optical disk medium to an increased thickness;

FIGS. 6A and 6B are schematic plan views illustrating a difference in recording capacity between the optical disk medium according to the present invention and a popular optical disk which has a center hole;

FIGS. 7A and 7B are schematic plan views illustrating a difference in display area for a picture, a character or the like between the optical disk medium according to the present invention and a popular optical disk which has a center hole;

FIG. 8 is a schematic plan view showing a turntable to which the present invention is applied;

FIG. 9 is a side elevational view, partly in section, of the turntable of FIG. 8;

FIG. 10 is a partial enlarged schematic sectional view showing a swollen portion at an outer peripheral portion of the optical disk medium of FIGS. 2A and 2B and a relief recess of the turntable of FIG. 9 corresponding to the swollen portion;

FIGS. 11 to 14 are schematic sectional views showing different modifications to the optical disk medium of FIGS. 2A and 2B and the turntable of FIG. 8;

FIG. 15 is a plan view of a large size (large diameter) metal substrate for use with an optical disk medium production method of the present invention;

FIG. 16 is a sectional view illustrating a step of forming a data recording layer in the optical disk medium production method of the present invention;

FIG. 17 is a sectional view illustrating a step of forming a reflection film in the optical disk medium production method of the present invention;

FIG. 18 is a sectional view illustrating a step of forming a protective layer in the optical disk medium production method of the present invention;

FIG. 19 is a sectional view illustrating a punching out step of an optical disk medium in the optical disk medium production method of the present invention;

FIGS. 20A and 20B are a schematic plan view and a schematic side elevational view, respectively, showing an entire optical disk medium produced by the production method of the present invention;

FIG. 21 is an enlarged schematic sectional view showing part of the optical disk medium of FIGS. 20A and 20B where the optical disk medium is applied to a one-sided disk;

FIG. 22 is an enlarged schematic sectional view showing part of the optical disk medium of FIGS. 20A and 20B where the optical disk medium is applied to a two-sided disk;

FIG. 23 is an enlarged schematic sectional view showing part of the optical disk medium of FIGS. 20A and 20B and illustrating that unnecessary reflected light from a picture-character layer does not mix into necessary reflected light by setting the thickness of a data recording layer of the optical disk medium to an increased thickness;

FIGS. 24A and 24B are schematic plan views illustrating a difference in recording capacity between the optical disk medium of FIGS. 20A and 20B and a popular optical disk which has a center hole;

FIGS. 25A and 25B are schematic plan views illustrating a difference in display area for a picture, a character or the like between the optical disk medium of FIGS. 20A and 20B and a popular optical disk which has a center hole;

FIG. 26 is a side elevational view, partly in section, showing part of an optical disk apparatus which reproduces the optical disk medium of FIGS. 20A and 20B;

FIG. 27 is a plan view showing a turntable of the optical disk apparatus of FIG. 26;

FIG. 28 is a sectional view taken along line A-A of FIG. 27;

FIG. 29 is a partial enlarged schematic sectional view showing a swollen portion at an outer peripheral portion of a popular optical disk medium and a relief recess of the turntable of FIG. 27 corresponding to the swollen portion; and

FIGS. 30A and 30B are schematic plan views showing modifications to a large size metal substrate in the present invention.

### DESCRIPTION OF THE PREFERRED EMBODIMENTS

An object to make it possible to draw or print a picture, a character or the like also on a data recording layer of an optical disk medium is achieved by a picture-character layer wherein a picture, a character or the like which can be visually observed through the data recording layer is drawn or printed on one face or on the opposite faces of a metal substrate. Another object to make it possible for the optical disk medium to be attracted to a turntable readily is achieved by a cutaway portion formed on an outer periphery of the turntable so as to allow part of the outer periphery of the optical disk medium to be picked therethrough to perform a mounting or removing operation of the optical disk medium on or from the turntable.

A further object to center an optical disk medium having no center hole thereon with a high degree of accuracy on a turntable is achieved by a disk receiving face of the turntable.

[Embodiment 1]

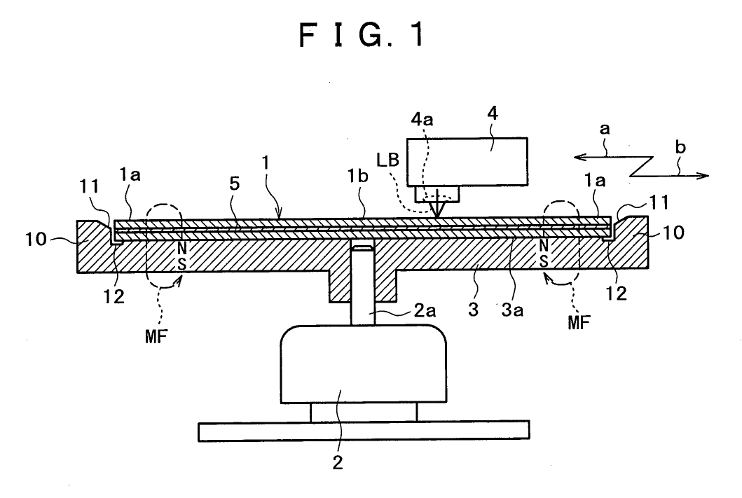

First, an outline of principal part of an optical disk apparatus of the present invention is described with reference to FIG. 1. An optical disk medium 1 of the present invention as represented by a compact disk (CD) and a digital versatile disk (DVD) is formed such that data is reproduced (read) therefrom using a light beam. However, the optical disk medium 1 may otherwise be formed such that data is magneto-optically recorded and/or reproduced (read) thereon and/or therefrom like a magneto-optical disk (MO). Although details of the optical disk medium 1 are hereinafter described, a metal substrate made of a magnetic substance is used as a disk substrate of the optical disk medium 1. It is to be noted that popular optical disk media use a disk substrate made of polycarbonate (PC).

A turntable 3 is secured by force fitting, adhesion, fastening by means of a screw or the like to an end of a motor shaft 2a of a spindle motor 2. While also details of the turntable 3 are hereinafter described, the turntable 3 is made of a magnetic substance. The turntable 3 is magnetized so as to have an N pole and an S pole in a thicknesswise direction so that the optical disk medium 1 may be fixedly attracted to a disk receiving face 3a of the turntable 3 by magnetic force MF of the turntable 3.

The optical disk medium 1 is rotated integrally with the turntable 3 by the spindle motor 2 while data (signals) recorded in concentric circles on one face or on the opposite faces of the optical disk medium 1 are read (reproduced) by means of a laser beam LB which is a beam of light emitted from an optical pickup 4. Different from common optical disk media, the optical disk medium 1 of the present invention does not have a center hole formed therein as hereinafter described in detail, and data are recorded over a wide range from an outer periphery to the center of the optical disk medium 1. Therefore, when the data of the optical disk medium 1 are read as described above, the optical pickup 4 successively accesses the optical disk medium 1 over a wide range from the outer periphery to the center in a radial direction (direction a or b) of the optical disk medium 1 to read the data from the optical disk medium 1. Thereupon, since the turntable 3 exists over the overall area on the lower face side of the optical disk medium 1, the optical pickup 4 reads the data from above, that is, from the opposite side to the turntable 3 with respect to the optical disk medium 1.

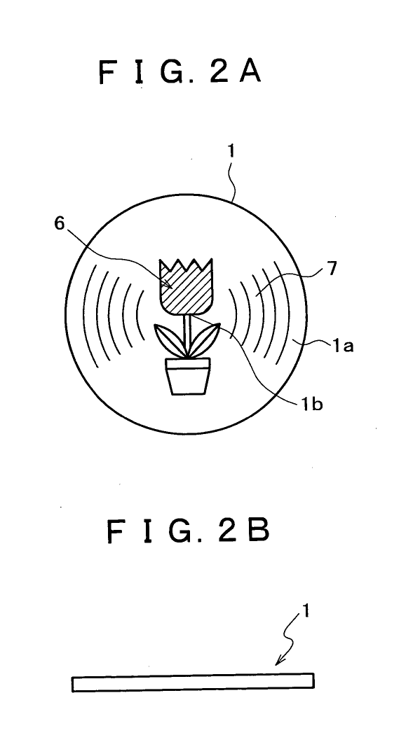

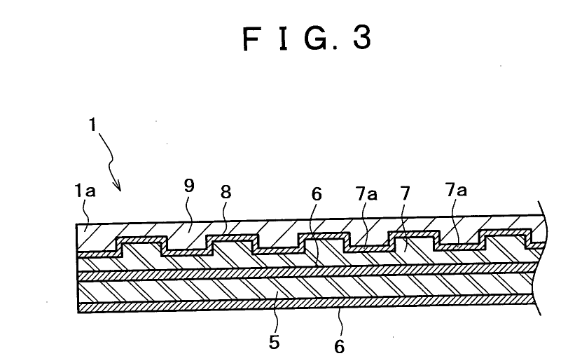

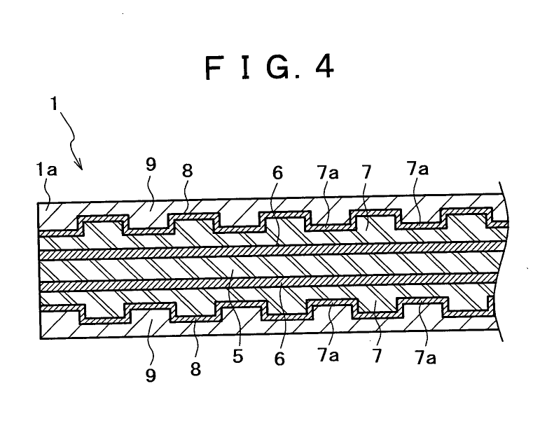

Now, details of the optical disk medium 1 of the present invention are described with reference to FIGS. 2 to 6A and 6B. It is to be noted that FIG. 3 is a sectional view showing details of the optical disk medium 1 where data are recorded only on one face of the optical disk medium 1 while FIG. 4 is a sectional view showing details of the optical disk medium 1 where data are recorded on the opposite faces of the optical disk medium 1. The disk substrate of the optical disk medium 1 is formed as a metal substrate 5 made of a magnetic material such as a thin disk of a metal material. The metal substrate 5 may be made of a material of, for example, SUS430 (magnetic stainless steel material) with a thickness equal to or less than 0.5 mm.

A picture-character layer 6 on which a picture or a character is drawn or printed is formed on one or both of the opposite faces of the metal substrate 5. Further, a data recording layer 7 made of a UV resin (ultraviolet curing resin) is formed on the picture-character layer 6. It is to be noted that data 7a each in the form of a concave portion of approximately 50 to 130 nm deep called pit are formed on concentric circles on the data recording layer 7. Although the concave portions of the data 7a are schematically shown in an emphasized fashion in FIGS. 3 and 4, actually the concave portions of the data 7a are so small that they cannot almost be visually identified with the eyes but look flat at a glance. Further, the pits are similar to those used in a ROM disk such as a CD or a DVD and are signal recording information common to optical disks.

In order to form the data recording layer 7, a UV resin layer is applied to the picture-character layer 6 first, and then a transparent stamper (embossing die for forming pits) is pressed against the UV resin layer. Then, in this state, ultraviolet rays are illuminated from above on the UV resin layer to make the UV resin layer cure thereby to form the pits, that is, the data recording layer 7. The data recording layer 7 (=UV resin layer) thereupon is a thickness T equal to or greater than 20 μm.

Further, in the optical disk medium 1, a reflecting film 8 which can pass light therethrough is formed from above the data recording layer 7 (from above the pit face) by sputtering. The reflecting film 8 may be formed from such a material as aluminum, aluminum alloy, silver, silver alloy, silicon or the like. The reflecting film 8 is a thin film having a thickness of approximately 10 to 20 nm and functions as a reflecting film for the laser beam LB illuminated from the aforementioned optical pickup 4 while maintaining the pit portions of the data recording layer 7.

Since the reflecting film 8 is a thin film, it has a partial light passing property while the reflection factor thereof is approximately 10 to 30%. Therefore, a user can visually observe a picture or a character on the picture-character layer 6 formed on the surface of the metal substrate 5 through the reflecting film 8.

A cover coat 9 is made of a transparent UV resin material or the like and formed on the reflecting film 8 and serves as a protective layer. The cover coat 9 is formed as a thin film, for example, by spin coating and then by UV illumination to cause the thin film to cure.

The optical pickup 4 illuminates the laser beam LB on the optical disk medium 1 from the cover coat 9 side through an objective lens 4a. The laser beam LB having passed through the cover coat 9 is reflected by the reflecting film 8 and returns to the optical pickup 4. The signals recorded on the reflecting film 8 can be read from a variation of the reflected light amount from the pits of the data recording layer 7. This is based on the same principle as that of a CD or a DVD.

It is to be noted that the optical disk medium 1 wherein signals are recorded on the opposite faces thereof as shown in FIG. 4 can be produced by applying, after a one-sided disk shown in FIG. 3 is produced, the steps later than the formation of the data recording layer 7 described hereinabove also to the rear face of the disk.

The optical disk medium 1 of the present invention has a characteristic that it itself is attracted to a magnet because the disk substrate is formed as the magnetic metal substrate 5. In a conventional optical disk medium, for example, in a mini disk (MD), it is necessary to adhere a metal piece called hub for being attracted to a magnet to the disk, while, in a CD or a DVD, a mechanism for fixing the disk such as a disk clamper is required. However, according to the present invention, a hub for attraction to a magnet, a disk clamper and so forth are not required, but the optical disk medium 1 can be attracted by itself to the disk receiving face 3a of the turntable 3 by the magnetic force MF of the turntable 3.

In particular, the disk receiving face 3a of the turntable 3 made of a magnetic substance is magnetized at a suitable position thereof such that the N pole and the S pole are directed in the upward and downward directions so as to form the turntable 3 as a magnet. As a result, since the metal substrate 5 of the optical disk medium 1 is attracted to the turntable 3 side by the magnetic force MF of the magnet of the turntable 3, the optical disk medium 1 can be attracted horizontally on (parallelly to) the disk receiving face 3a of the turntable 3.

Thereupon, since the entire metal substrate 5 of the optical disk medium 1 is attracted parallelly on the disk receiving face 3a of the turntable 3, warping of the optical disk medium 1 is corrected to improve the flatness of the overall optical disk medium 1 significantly. Accordingly, when the laser beam LB is illuminated on the data recording layer 7 from the optical pickup 4 to read the reflected light, the focusing error can be reduced and reading of data can be performed always with a high degree of accuracy.

Further, since the metal substrate 5 is used as the disk substrate, the rigidity of the entire optical disk medium 1 is raised when compared with a conventional optical disk medium wherein the disk substrate is made of polycarbonate (PC) like ordinary CDs and DVDs. This gives rise to an advantage that, where the disk rigidities are equal, the thickness of the entire optical disk medium 1 can be reduced.

When the optical pickup 4 is used for signal reproduction, it is desirable to read only light reflected from the reflecting film 8. However, since the reflecting film 8 has a partial light passing property, the light having passed through the reflecting film 8 generates unnecessary reflected light at the picture-character layer 6.

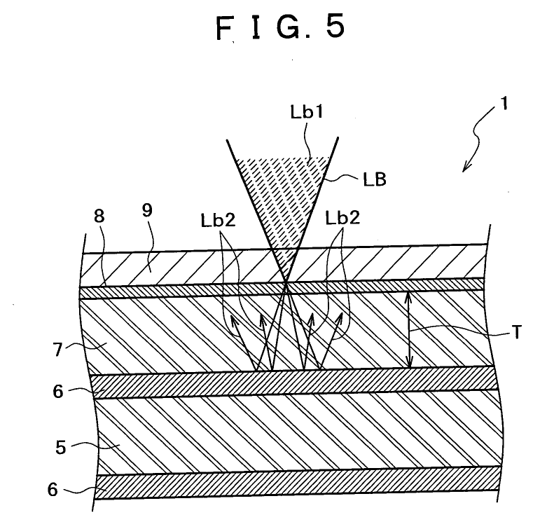

Therefore, in the present invention, the thickness T (=distance between the picture-character layer 6 and the reflecting film 8) of the UV resin layer (data recording layer 7) is made comparatively great to reduce unnecessary reflected light (refer to FIG. 5). The laser beam LB focused on the reflecting film 8 is thereafter dispersed, and the light component thereof having passed through the data recording layer 7 is projected on the picture-character layer 6 as a spot of a diameter which increases as the thickness of the UV resin layer (data recording layer 7) increases. Therefore, the amount of unnecessary reflected light Lb2 reflected by the picture-character layer 6 which leaks into necessary reflected light Lb1 reflected by the reflecting film 8 can be reduced, and the degree of reading accuracy of data can be improved significantly.

If a two-layer recording disk used actually as a DVD is described as an example, then reproduction is permitted where the distance between the first and second layers of the reflecting film is 20 μm. It is proved from actual results that, if a distance of at least 20 μm is provided, then even if some unnecessary reflected light from a different layer exists, the system operates normally. By the condition that the reflecting film 8 is formed as a reflecting film having a partial light passing property and the condition that the UV resin layer (data recording layer 7) is formed with an increased thickness (equal to or more than 20 μm) to a level with which unnecessary reflected light Lb2 from the picture-character layer 6 does not matter, it becomes possible to insert a print of a picture or a character also on the signal recording face side of the disk. According to the related art, although printing on the rear face with respect to the signal recording face is possible, it is impossible to insert a print on the signal recording face side.

The optical disk medium 1 of the present invention is characterized also in that, since the disk surface is covered with the cover coat 9 as a protective layer, the disk surface is free from convex and concave shapes and can be formed as a flat face and further in that the optical disk medium 1 does not have a center hole (hole at the center of the disk) as seen from FIG. 2 which shows the disk fully. A conventional optical disk medium essentially requires a center hole used for centering when the disk is fixed to a spindle motor.

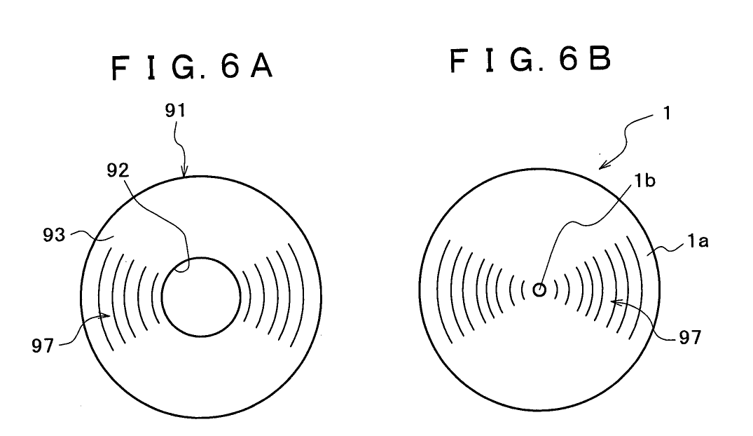

However, the optical disk medium 1 of the present invention has a structure of the turntable 3 of the spindle motor 2 as hereinafter described so that the optical disk medium 1 can be centered even if it does not have a center hole. Further, since the center hole is eliminated, the data recording layer 7 can be expanded by a great amount to a disk central portion 1b, and as a result, the recording capacity of the optical disk medium 1 can be increased. In particular, FIG. 6A shows a popular optical disk medium 91 having a center hole perforated therein like a CD or a DVD. Since the optical disk medium 91 has a center hole 92 perforated at the center of the disk, the diameter of the inner circumference side of a data recording area 97 extending from a disk outer circumferential portion 93 to an inner circumferential portion of the disk cannot be reduced. Consequently, the optical disk medium 91 has a limitation to the increase of the recording capacity.

In contrast, with the optical disk medium 1 of the present invention, since a center hole is not perforated at the center of the disk as seen in FIG. 6B, the data recording layer 7 can be expanded by a great amount to the disk center side such that it ranges from a disk outer circumferential portion 1a to the position of a diameter of approximately 0.5 mm of the disk central portion 1b. Further, in a conventional optical disk apparatus, since usually the data recording face of an optical disk medium 1 rotated by the turntable 3 is directed downwardly and data is read from the data recording face by means of the optical pickup from the lower side of the optical disk medium 1, if it is tried to decrease the diameter of the inner side of the center hole 92, then the optical pickup comes to interfere with the spindle motor. Also this provides a limitation to expansion of the recording capacity.

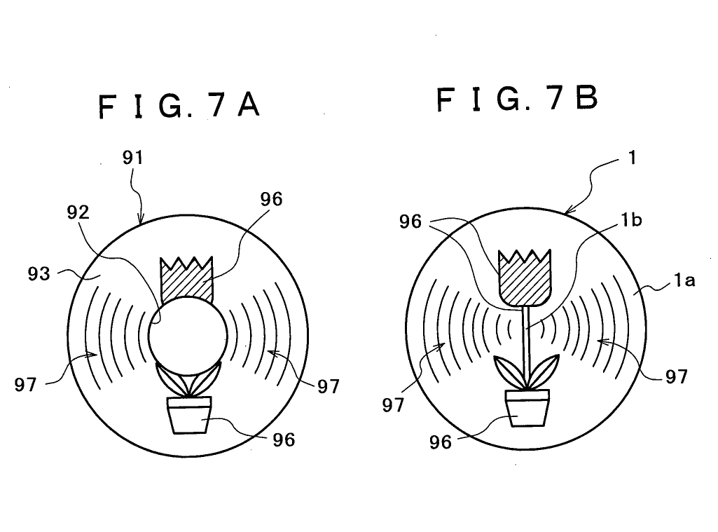

In contrast, in the optical disk medium 1 of the present invention, since the spindle motor 2 and the optical pickup 4 are disposed on the opposite sides to each other across the optical disk medium 1, even if the optical pickup 4 accesses the inner circumference side of the disk, the optical pickup 4 and the spindle motor 2 do not interfere with each other. Accordingly, also from the fact that the optical disk medium 1 does not have a center hole and the fact that the optical pickup 4 can access up to the disk central portion 1b of the optical disk medium 1 without interfering with the spindle motor 2 at all, the data recording layer 7 can be expanded to achieve increase of the recording capacity. FIG. 7A shows another popular optical disk medium 91 having a center hole perforated therein like a CD or a DVD. With the optical disk medium 91 shown in FIG. 7A, a picture-character layer 96 formed by drawing or printing of a picture, a character or the like is limited significantly by the center hole 92 perforated at the center of the disk. Consequently, it is impossible to make the most of the overall occupation area of the disk including the center hole 92 portion to display a picture, a character or the like in a large size and efficiently.

In contrast, with the optical disk medium 1 of the present invention, since it does not have a center hole as shown in FIG. 7B, the picture-character layer 6 including the disk central portion 1b of the optical disk medium 1 can be formed over a wide range. Accordingly, such a display as a picture or a character is not limited at all by the center hole, and a picture, a character or the like can be displayed efficiently in a large size and the fine appearance, commodity value and so forth of the optical disk medium can be enhanced significantly.

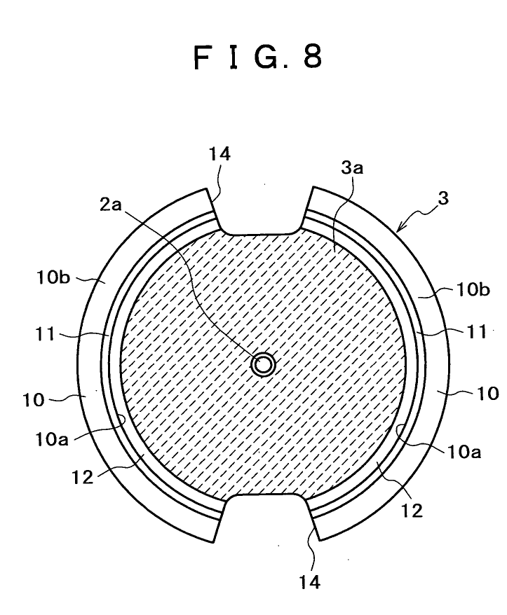

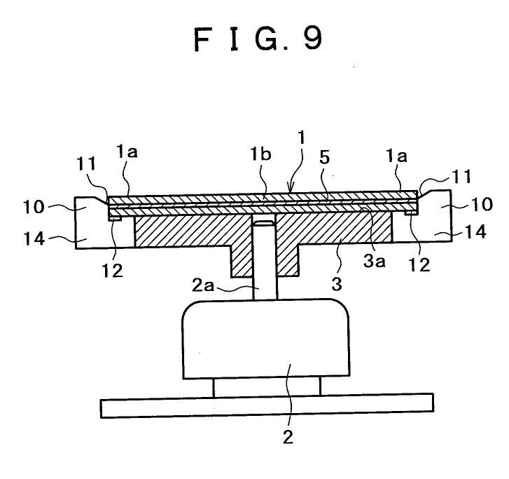

Now, the turntable 3 of the present invention is described with reference to FIGS. 8 and 9. The turntable 3 of the present invention is formed as a unitary member from a magnet (bonded magnet, sintered magnet or the like) and is magnetized itself such that the N pole and the S pole are directed in upward and downward directions to exert magnetic force MF. The turntable 3 is characterized also in that it has an outer diameter greater than that of the optical disk medium 1 and a cylindrical rib 10 for centering the optical disk medium 1 is formed integrally and concentrically on the outer periphery of the disk receiving face 3a. As shown in FIG. 1, the optical disk medium 1 is positioned such that the outer diameter thereof coincides with the inner diameter of the rib 10 and is attracted to the disk receiving face 3a by the magnetic force MF. The outer diameter of the optical disk medium 1 and the inner diameter of the rib 10 are designed such that a gap of approximately 100 μm may be left therebetween taking part tolerances of them into consideration.

Also by the centering method, the centering accuracy within ±100 μm can be achieved, and thus, the optical disk medium 1 can be centered with a degree of accuracy equal to that achieved by a conventional centering method which relies upon a center hole. The rib 10 plays a role also as a stopper for preventing the optical disk medium 1 from escaping in a circumferential direction during rotation of the optical disk medium 1. This method allows even the optical disk medium 1 having no center hole to be centered on the turntable 3 with a degree of accuracy substantially equal to that achieved by the conventional method.

As seen from FIGS. 8 and 9, the turntable 3 of the present invention is a chamfered face 11 at a corner portion between an inner circumferential face 10a and an upper face 10b of the rib 10 so that, when the optical disk medium 1 is inserted into the inside of the rib 10 so as to be attracted to (mounted on) the disk receiving face 3a, the chamfered face 11 may guide the outer periphery of the optical disk medium 1 to introduce the optical disk medium 1 smoothly into the inside of the rib 10. Accordingly, a mounting operation of the optical disk medium 1 on the disk receiving face 3a of the turntable 3 can be performed smoothly.

It is to be noted that the height of the rib 10 is smaller than the thickness of the optical disk medium 1.

In order to assure good operability when the optical disk medium 1 is mounted on or removed from the turntable 3, the optical pickup 4 is moved to the outer side with respect to the outermost periphery of the disk. Thereupon, if the height of the rib 10 is greater than the thickness of the disk, then there is the possibility that, when a portion of the optical pickup 4 such as the objective lens 4a which is positioned closely to the optical disk medium 1 moves in a radial direction of the turntable 3, it may be caught by the rib 10. If the height of the rib 10 is smaller than the thickness of the optical disk medium 1, then there is no possibility that the portion may be caught.

Further, one or a plurality of cutaway portions 14 are formed on the outer periphery of the turntable 3. The cutaway portions 14 are portions into which fingers of a user are inserted to pick the optical disk medium 1 in order to mount or remove the optical disk medium 1 on or from the turntable 3. If the turntable 3 has no such cutaway portion 14, then the rib 10 of the turntable 3 makes an obstacle and makes it difficult particularly for the user to remove the optical disk medium 1.

According to the present invention, the optical disk medium 1 is attracted to the turntable 3 by the magnetic force MF over a wide range from the inner periphery to the outer periphery thereof. With the method of the invention, even if the optical disk medium 1 should have some warping, it is forced to follow the disk receiving face 3a having a high rigidity by the attracting force of the magnetic force MF. This indicates that, if the disk receiving face 3a has a good flatness, then even if the optical disk medium 1 has a comparatively great amount of warping, when it is actually used, it is corrected to a state wherein it has a good flatness. Accordingly, if the flatness of the disk receiving face 3a is improved when compared with the specifications regarding the out-of-plane deflection or the flatness prescribed by the standards for the optical disk medium 1, then when it is actually used, there is an effect that the amount of warping of the optical disk medium 1 is decreased. In other words, the standards for the warping of the optical disk medium 1 can be moderated.

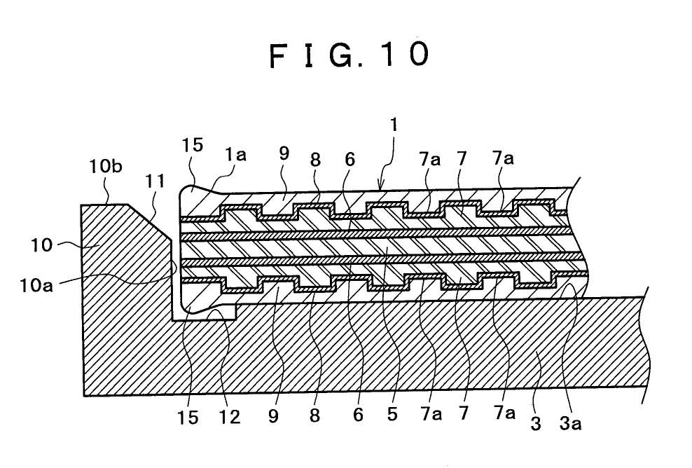

Referring also to FIGS. 8 to 10, the turntable 3 of the present invention has an annular recess or groove 12 for providing a relief in the heightwise direction along an outer circumferential portion of the disk receiving face 3a. The recess 12 is provided as a relief for a portion of the optical disk medium 1 within a range of 1 to 2 mm from the outer peripheral end of the optical disk medium 1 because the portion has a thickness greater by approximately 50 μm or less. In particular, in the optical disk medium 1, the cover coat 9 is formed as seen in FIG. 10 by spin coating. While the spin coating forms a film using centrifugal force, there is a nature that the UV resin accumulates only at the outermost peripheral portion of the optical disk medium 1 because of the surface tension thereby to form a swollen portion 15 at which the film has an increased thickness. If the recess 12 for a relief is not provided on the turntable 3, then when the optical disk medium 1 is attracted to the disk receiving face 3a of the turntable 3, there is the possibility that the swollen portion 15 may ride on (interfere with) the disk receiving face 3a thereby to rather increase the warping of the optical disk medium 1.

[Embodiment 2]

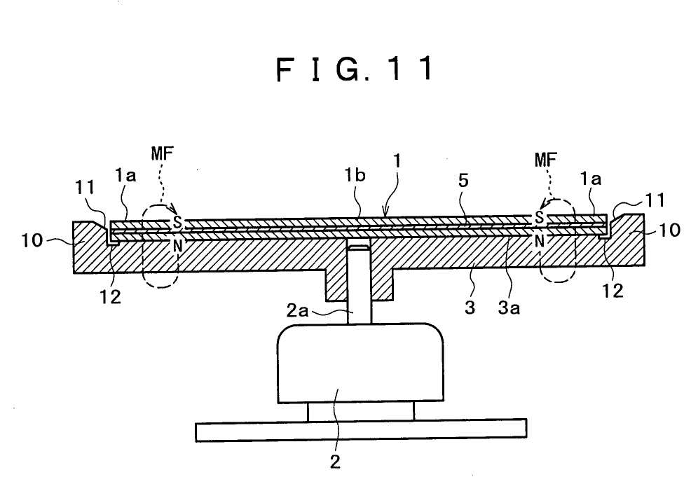

FIG. 11 shows an embodiment 2 of the present invention. Referring to FIG. 11, a metal substrate 5 of an optical disk medium 1 is magnetized so that the optical disk medium 1 is attracted to a disk receiving face 3a of a turntable 3 formed from a magnetic substance such as an iron material by magnetic force MF of the metal substrate 5.

[Embodiment 3]

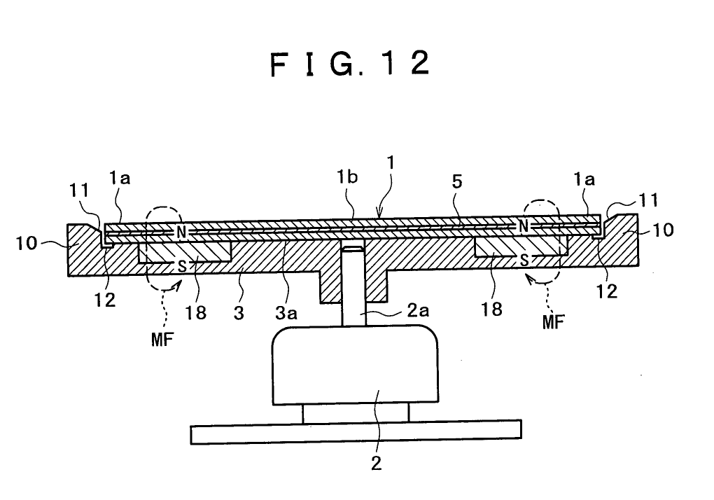

FIG. 12 shows an embodiment 3 of the present invention. Referring to FIG. 12, a plurality of magnets 18 are embedded in a disk receiving face 3a of a turntable 3 so that the optical disk medium 1 is attracted to the disk receiving face 3a of the turntable 3 by magnetic force MF of the magnets 18. In this instance, the turntable 3 may be formed from a nonmagnetic material such as a plastics material.

[Embodiment 4]

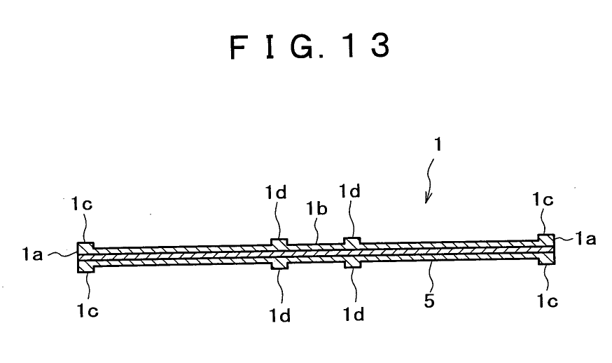

FIG. 13 shows an embodiment 4 of the present invention. Referring to FIG. 13, an annular rib 1c and/or an annular rib Id are formed at outer and/or inner circumferential portions of an optical disk medium 1 on at least one of upper and lower faces of the optical disk medium 1. More particularly, where the optical disk medium 1 is formed as a one-sided disk, the annular rib 1c and/or annular rib id are formed on the lower face of the optical disk medium 1 (face opposite to a data recording layer 7). On the other hand, where the optical disk medium 1 is formed as a double-sided disk, the annular rib 1c and/or annular rib Id are formed on the opposite upper and lower faces of the optical disk medium 1. Where such an annular rib 1c or 1d is formed on the optical disk medium 1, even if the optical disk medium 1 is placed inadvertently on a desk or the like, the cover coat 9, picture-character layer 6 and so forth can be prevented from being damaged inadvertently.

[Embodiment 5]

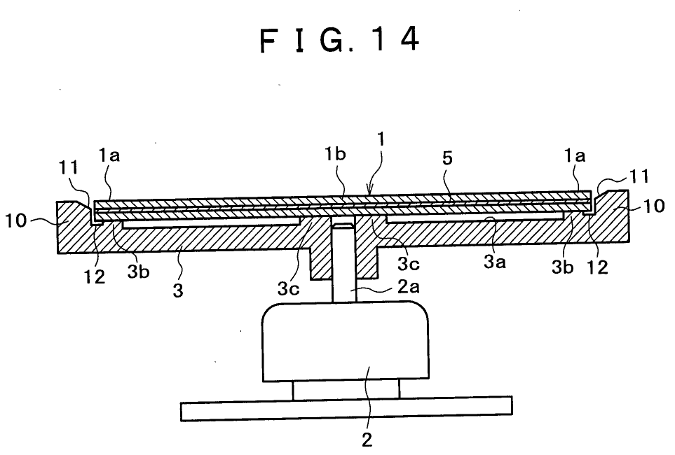

FIG. 14 shows an embodiment 5 of the present invention. Referring to FIG. 14, annular ribs 3b and 3c are formed on outer and inner circumferential portions of a motor shaft 2a of a turntable 3 such that the optical disk medium 1 is received horizontally on the annular ribs 3b and 3c on the inner and outer circumferences. In this manner, the disk receiving face 3a of the turntable 3 need not necessarily be an entirely flat face.

[Optical Disk Medium Production Method]

An object to expand a data recording area and a display area for a picture, a character and so forth of an optical disk medium is achieved, when a plurality of small-size optical disk media are to be produced on a large-size metal substrate upon production of optical disk media, by making the most of an overall occupation area of each small-size optical disk medium without working a center hole at the center of the small-size optical disk. Further, another object to form a protective layer on a reflecting film of a plurality of small-size optical disk media at a time by spin coating is achieved by rotation control of a large-size metal substrate within a horizontal plane around the center hole. A further object to keep the rotation balance of the large-size metal substrate upon rotation control of the large-size metal substrate within a horizontal plane around the center hole is achieved by a balancing hole formed at a position in the proximity of the outer periphery of the large-size metal substrate in a substantially opposing relationship to a positioning hole formed at another position in the proximity of the outer periphery of the large-size metal substrate.

Further, an object to produce a plurality of small-size optical disk media efficiently at a time from a single large-size metal substrate is achieved by setting a plurality of small-size optical disk medium working regions disposed in a ring-like arrangement around the center of rotation of the large-size metal substrate, forming small-size optical disk media in the small-size optical disk medium working regions and cutting out, after the small-size optical disk media are formed, the small-size optical disk medium working regions at a time from the large-size metal substrate by presswork.

Furthermore, an object to prevent a swollen portion of a spin coat material from being formed at an outer peripheral portion of a protective film spin coated on a reflecting film in the small-size optical disk medium working regions is achieved by press working, when a plurality of small-size optical disk medium working regions are formed at a time by press work to produce a plurality of small-size optical disk media, each of the small-size optical disk medium working regions at a position displaced inwardly by equal to or more than 2 mm from the outermost peripheral position.

In addition, an object to produce six small-size optical disk media at a time from a single large-size metal substrate is achieved by forming the large-size metal substrate with a diameter substantially 120 mm, and forming the small-size optical disk medium working regions disposed in a ring-like arrangement with a diameter substantially equal to or smaller than 53 mm.

[Embodiment 6]

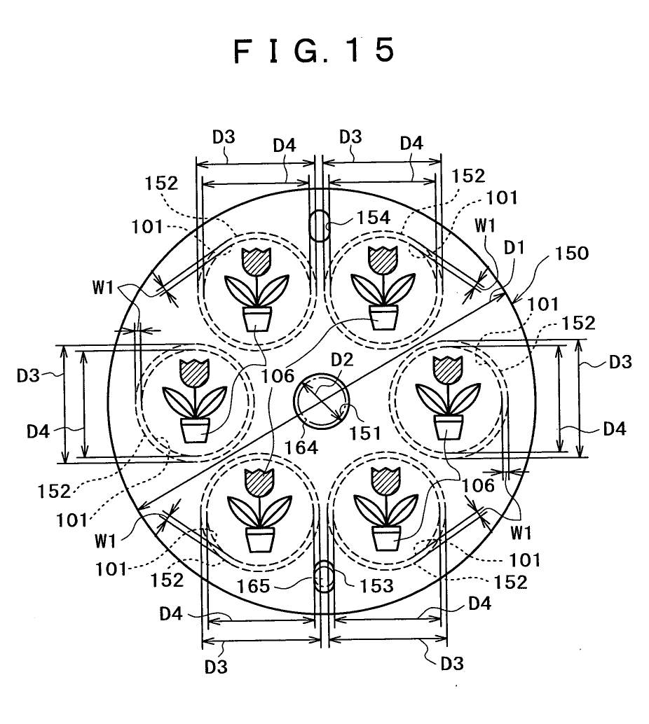

First, an embodiment of an optical disk medium production method of the present invention is described with reference to FIGS. 15 to 19. FIG. 15 shows an embodiment wherein a plurality of, for example, six, small-size (small-diameter) optical disk media 101 are produced at a time from a single large-size (large-diameter) metal substrate 150 in the form of a disk. A center hole 151 of a circular shape is formed at the center of the large-size metal substrate 150, and six small-size optical disk medium working regions 152 of a circular shape are disposed at equal intervals (six equally spaced arrangement) in a ring-like arrangement around an outer periphery of the center hole 151. The small-size optical disk media 101 are formed in a substantially concentric relationship individually in the six small-size optical disk medium working regions 152.

Thereupon, as regards dimensions, for example, the diameter D1 of the large-size metal substrate 150 is substantially 120 mm, and the diameter D2 of the center hole 151 is substantially 15 mm. Further, the diameter D3 of the six small-size optical disk medium working regions 152 is equal to or smaller than 53 mm, and the diameter D4 of the small-size optical disk media 101 is 30 mm. Accordingly, the diameter D3 of the small-size optical disk medium working regions 152 and the diameter D4 of the small-size optical disk media 101 are different by less than 23 mm, and if each of the small-size optical disk media 101 is worked substantially concentrically in a corresponding small-size optical disk medium working region 152, a free space of a width W1 equal to or smaller than 11.5 mm exists between the small-size optical disk medium working region 152 and the outermost periphery of the small-size optical disk medium 101.

It is to be noted that a single positioning hole 153 in the form of a hole, a cutaway portion or the like and one or a plurality of balancing holes 154 each in the form of a hole, a cutaway portion or the like are formed symmetrically with each other with respect to the center hole 151 at positions in the proximity of an outer periphery of the large-size metal substrate 150. The center hole 151 and the positioning hole 153 are used as a positioning reference or a rotational reference for the large-size metal substrate 150 upon spin coating hereinafter described or the like. Further, the balancing holes 154 are used to keep a rotational balance when the large-size metal substrate 150 is controlled to rotate within a horizontal plane around the center hole 151 upon spin coating hereinafter described or the like (that is, to correct the rotational balance of the large-size metal substrate 150 lost because the positioning hole 153 is formed at a position displaced from the center hole 151). Accordingly, a single hole having the same shape as that of the positioning hole 153 may be formed as the single balancing hole 154 at a position symmetrical with the positioning hole 153 with respect to the center hole 151, or two holes having a size equal to one half that of the positioning hole 153 may be formed at symmetrical positions with respect to the center hole 151.

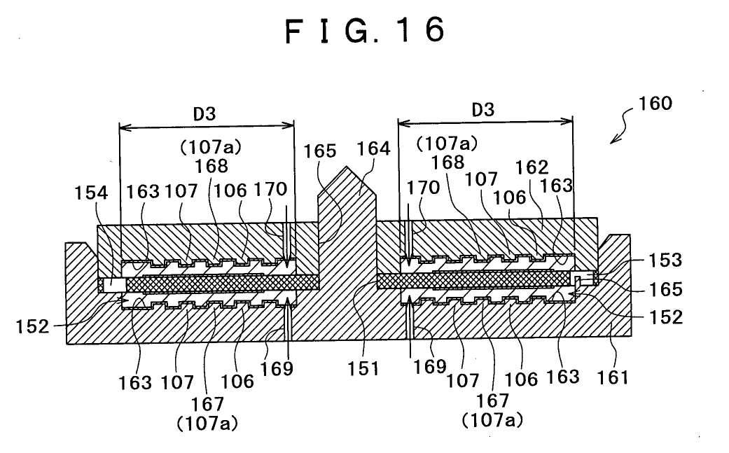

Now, a method of producing six small-size optical disk media 101 using a single large-size metal substrate 150 is described with reference to FIGS. 16 to 19. Although the six small-size optical disk media 101 may each be such a one-sided disk as hereinafter described, the description here is given of a production method of such two-sided disks as hereinafter described. It is to be noted that FIGS. 16 to 19 are schematic views wherein each element is shown exaggerated in the thicknesswise direction.

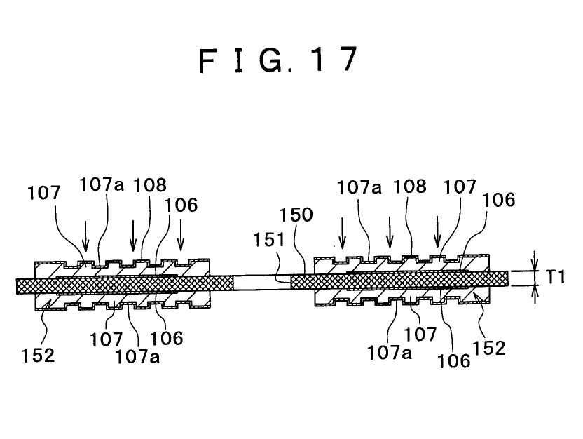

First, an SUS430 material (magnetic stainless steel material) having a thickness T1 equal to or smaller than 0.5 mm (refer to FIG. 17) can be applied as the large-size metal substrate 150 as seen in FIG. 16. A picture-character layer 106 on which a picture, a character or the like is drawn or printed in advance as hereinafter described is formed on the center side in the six small-size optical disk medium working regions 152 on the opposite faces of the large-size metal substrate 150.

Further, as shown in FIG. 16, six cavities 163 of a shallow cylindrical shape are formed at positions individually opposing to the six small-size optical disk medium working regions 152 of the large-size metal substrate 150 shown in FIG. 15 between a pair of metal dies 161 and 162 of an injection molding machine 160. The six cavities 163 have a diameter equal to or smaller than 53 mm equally to the diameter D3 of the six small-size optical disk medium working regions 152 of the large-size metal substrate 150.

Thus, the large-size metal substrate 150 is mounted between the paired metal dies 161 and 162 of the injection molding machine 160 and set at a position wherein it crosses the center positions in the thicknesswise direction of the six circular cavities 163 so that the picture-character layer 106 formed at the six locations of the large-size metal substrate 150 is positioned at the center positions of the six cavities 163 or the like as seen in FIG. 16.

Thereupon, for example, the center hole 151 of the large-size metal substrate 150 is fitted on a center pin 164 of the metal mold 161 and the positioning hole 153 of the large-size metal substrate 150 is fitted with a positioning pin 165 of the metal mold 161 to position the large-size metal substrate 150 with respect to the six cavities 163. It is to be noted that also the other metal mold 162 is engaged at a center hole 66 thereof with the center pin 164 of the metal mold 161 and positioned with respect to the metal mold 161 by some other positioning means not shown.

On the other hand, pit forming concave-concave shape portions 167 and 168 for forming concave and convex shapes of approximately 50 to 130 nm as data (signals) 107a are formed in advance on opposing faces 161a and 162a in the thicknesswise direction in the six cavities 163 of the paired metal dies 161 and 162 as seen in FIG. 16.

Thus, molten transparent resin (for example, polycarbonate (PC)) is injected at a time towards the picture-character layers 106 on the opposite faces of the six small-size optical disk medium working regions 152 of the large-size metal substrate 150 within the six cavities 163 from injection gates 169 and 170 of the paired metal dies 161 and 162 as seen in FIG. 16. Consequently, a pair of data recording layers 107 having pits of concave and convex shapes of approximately 50 to 130 nm as data 107a formed on the surfaces thereof by the paired concave-concave shape portions 167 and 168 are outsert molded (injection molded) in the six small-size optical disk medium working regions 152 shown in FIG. 15 on the surfaces of the picture-character layers 106 on the opposite faces of the large-size metal substrate 150.

Then, after the data recording layers 107 each formed from a transparent resin layer become cool, the paired metal dies 161 and 162 are removed and the large-size metal substrate 150 is taken out to the outside of the injection molding machine 160. Through the steps described above, a process of forming the data recording layers 107 having a thickness of 10 to 20 μm or more and having a light passing property is completed.

Then, a pair of reflecting films 108 each in the form of a thin film having a light passing property as hereinafter described and having a thickness of approximately 10 to 20 nm are successively formed one by one face on the surfaces of the data recording layers 107 on the opposite faces of the six small-size optical disk medium working regions 152 of the large-size metal substrate 150 as seen in FIG. 17 by sputtering.

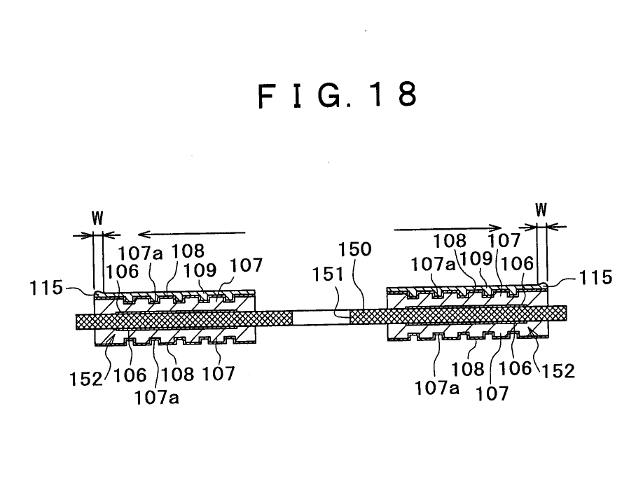

Thereafter, a pair of protective films 109 made of a transparent UV resin material or the like as hereinafter described are successively formed one by one face on the surfaces of the reflecting films 108 on the opposite faces of the six small-size optical disk medium working regions 152 of the large-size metal substrate 150 as seen in FIG. 18 by spin coating.

Thereupon, the large-size metal substrate 150 is driven to rotate at a high speed within a horizontal plane around the center hole 151 by rotating means not shown and the rotational balance of the large-size metal substrate 150 lost by the positioning hole 153 is corrected by the balancing hole 154 so that the large-size metal substrate 150 can rotate stably at a high speed due to the stabilized rotational balance.

On the other hand, as shown in FIG. 18, a swollen portion 115 of each of the protective films 109 is formed naturally in a region of a width W of equal to or less than 2 mm in the outermost peripheral region on each of the opposite faces of the six small-size optical disk medium working regions 152 by centrifugal force of the protective film 109 upon spin coating.

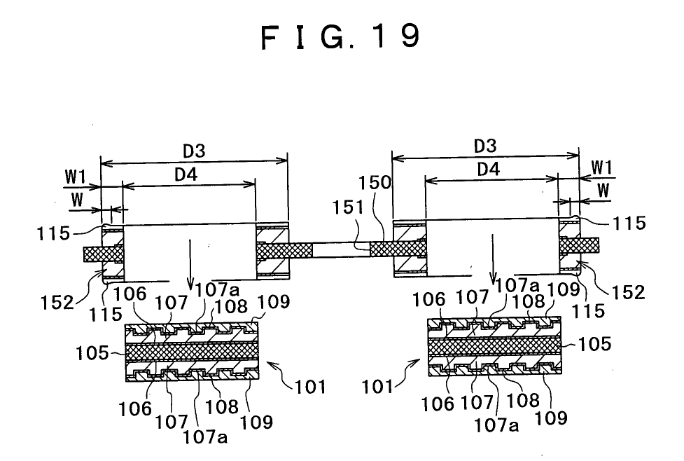

Therefore, at a final stage, as shown in FIG. 19, the inner side of each of the six small-size optical disk medium working regions 152 of the diameter D3 equal to or smaller than 53 mm of the single large-size metal substrate 150 is worked substantially concentrically in a circular shape of the diameter D4 by press work by a press machine to cut out the six small-size optical disk media 101 of the diameter D4 of 30 mm at a time thereby to complete the production of the six small-size optical disk media 101.

According to such a production method of the small-size optical disk media 101 as described above, although the swollen portion 115 of each protective film 109 is formed naturally within a region of a width W of equal to or less than 2 mm in the outermost circumferential region of each of the six small-size optical disk medium working regions 152 upon spin coating illustrated in FIG. 18, by working, upon press work, the small-size optical disk media 101 of the diameter D4 of 30 mm substantially concentrically on the inner side of each of the six small-size optical disk medium working regions 152 of the diameter D3 of equal to or less than 53 mm as seen in FIG. 19, the inner side of the swollen portion 115 of the protective film 109 of the width W=equal to or less than 2 mm with respect to a free space of W1=equal to or less than 11.5 mm in the outermost circumferential region within each of the six small-size optical disk medium working regions 152 is worked by the press work while the swollen portion 115 of the protective film 109 of the width W=equal to or less than 2 mm remains in the free space. Accordingly, the swollen portion 115 of the protective film 109 does not exist any more in the outermost circumferential region of each of the six small-size optical disk media 101 produced in such a manner as described above.

Accordingly, according to the optical disk medium production method of the present invention, six small-size optical disk media 101 wherein no swollen portions 115 of the protective films 109 are generated (present) at all in the outermost circumferential region can be produced at a time with a high degree of accuracy. Further, the six small-size optical disk media 101 produced by the optical disk medium production method of the present invention has no center hole therein.

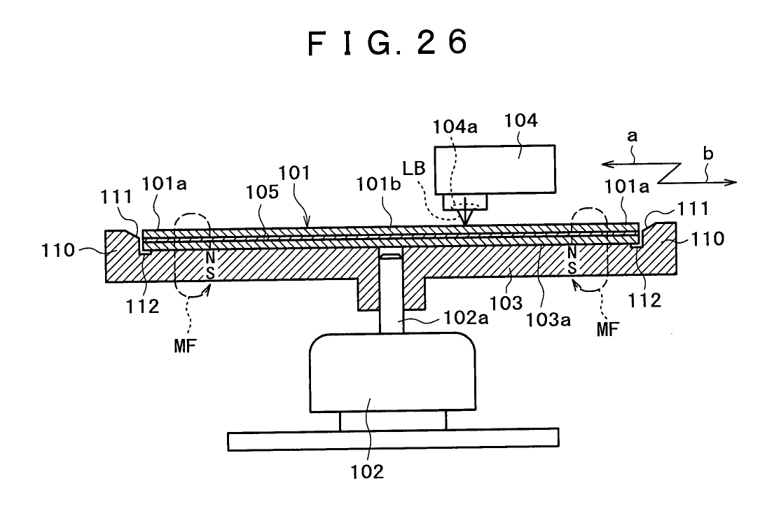

Now, an outline of principal part of an optical disk apparatus for reproducing the small-size optical disk medium of the present invention is described with reference to FIG. 26. The small-size optical disk medium 101 of the present invention is subject to reproduction (reading) of data using a light beam as represented by a CD or a DVD. The small-size optical disk medium 101, however, may otherwise be subject to recording and/or reproduction (reading) of data by a magneto-optical system like a magneto-optical disk (MO). Although details of the small-size optical disk medium 101 are hereinafter described, a metal substrate made of a magnetic substance is used as the disk substrate of the small-size optical disk media 101. It is to be noted that popular optical disk media include a disk substrate made of polycarbonate (PC).

A turntable 103 is secured by force fitting, adhesion, fastening by means of a screw or the like to an end of a motor shaft 102a of a spindle motor 102. While also details of the turntable 103 are hereinafter described, the turntable 103 is made of a magnetic substance. The turntable 103 is magnetized so as to have an N pole and an S pole in a thicknesswise direction so that the small-size optical disk medium 101 may be attracted (fixed) to a disk receiving face 103a of the turntable 103 by magnetic force MF of the turntable 103.

The small-size optical disk medium 101 is rotated integrally with the turntable 103 by the spindle motor 102 while data (signals) recorded in concentric circles on one face or on the opposite faces of the small-size optical disk medium 101 are read (reproduced) by means of a laser beam LB which is a beam of light emitted from an optical pickup 104. Different from common optical disk media, the small-size optical disk medium 101 of the present invention does not have a center hole formed therein as hereinafter described in detail, and data are recorded over a wide range from an outer periphery to the center of the small-size optical disk medium 101. Therefore, the optical pickup 104 successively accesses the small-size optical disk medium 101 over a wide range from the outer periphery to the center in a radial direction (direction a or b) of the small-size optical disk medium 101 to read the data from the small-size optical disk medium 101. Thereupon, since the turntable 103 exists over the overall area on the lower face side of the small-size optical disk medium 101, the optical pickup 104 reads the data from above, that is, from the opposite side to the turntable 103 with respect to the small-size optical disk medium 101.

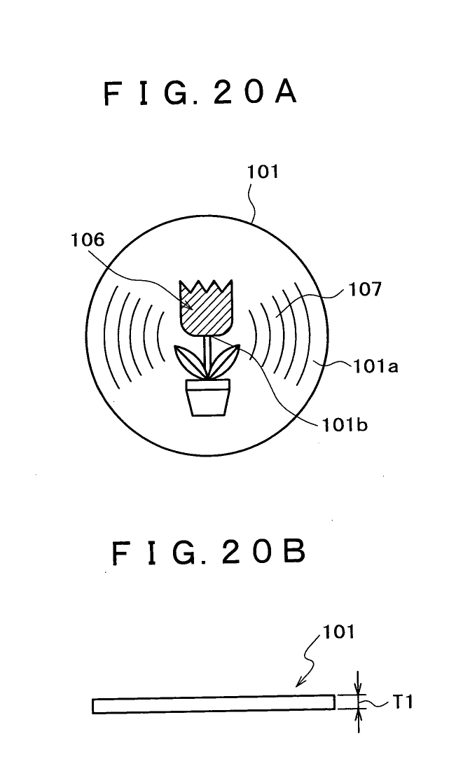

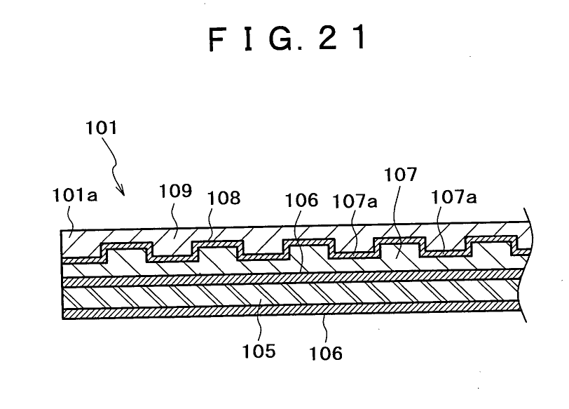

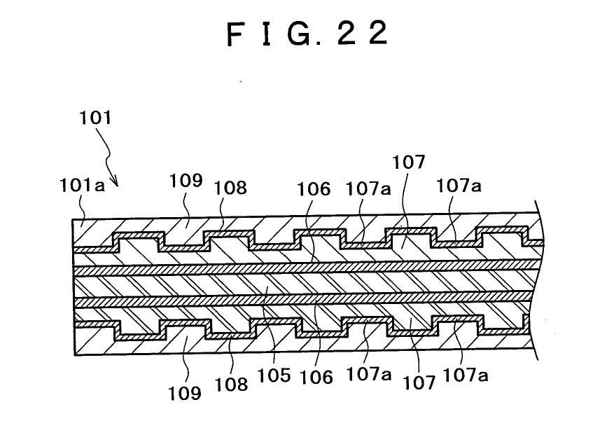

Now, details of the small-size optical disk medium 101 of the present invention are described with reference to FIGS. 20A and 20B to 25A and 25B. It is to be noted that FIG. 21 shows details of the small-size optical disk medium 101 where data are recorded only on one face of the small-size optical disk medium 101 while FIG. 22 shows details of the small-size optical disk medium 101 where data are recorded on the opposite faces of the small-size optical disk medium 101. The disk substrate of the small-size optical disk medium 101 is formed as a metal substrate 105 made of a magnetic material such as a thin disk of a metal material. The metal substrate 105 may be made of a material of, for example, SUS430 (magnetic stainless steel material) with a thickness equal to or smaller than 0.5 mm.

A picture-character layer 106 on which a picture or a character is drawn or printed is formed on one or both of the opposite faces of the metal substrate 105. Further, a data recording layer 107 made of a transparent resin is formed on the picture-character layer 106. It is to be noted that data (signals) 107a each in the form of a concave portion of approximately 50 to 130 nm deep called pit are formed on concentric circles on the data recording layer 107. It is to be noted that, although the concave portions of the data 107a are schematically shown in an emphasized fashion in FIGS. 21 and 22, actually the concave portions of the data 107a are so small that they cannot almost be visually identified with the eyes but look flat at a glance. Further, the pits are similar to those used in a ROM disk such as a CD or a DVD and are signal recording information common to optical disks.

As described hereinabove, the data recording layer 107 is formed simultaneously with the data 107a from the transparent resin layer injection molded on the picture-character layer 106 by the injection molding machine 160. The thickness T of the data recording layer (=transparent resin layer) 107 at this time is equal to or greater than 20 μm.

Further, in the small-size optical disk medium 101, a reflecting film 108 which can pass light therethrough is formed from above the data recording layer 107 (from above the pit face) by sputtering. The reflecting film 108 may be formed from such a material as aluminum, aluminum alloy, silver, silver alloy, silicon or the like. The reflecting film 108 is a thin film having a thickness of approximately 10 to 20 nm and functions as a reflecting film for a laser beam LB illuminated from the aforementioned optical pickup 104 hereinafter described while maintaining the pit portions of the data recording layer 107.

Since the reflecting film 108 is a thin film, it has a partial light passing property while the reflection factor thereof is approximately 10 to 30%. Therefore, a user can visually observe a picture or a character on the picture-character layer 106 formed on the surface of the metal substrate 105 through the reflecting film 108.

A protective film 109 which is a cover coat made of a transparent UV resin material or the like is formed on the reflecting film 108. The protective film 109 is formed as a thin film, for example, by spin coating and then by UV (ultraviolet rays) illumination to cause the thin film to cure.

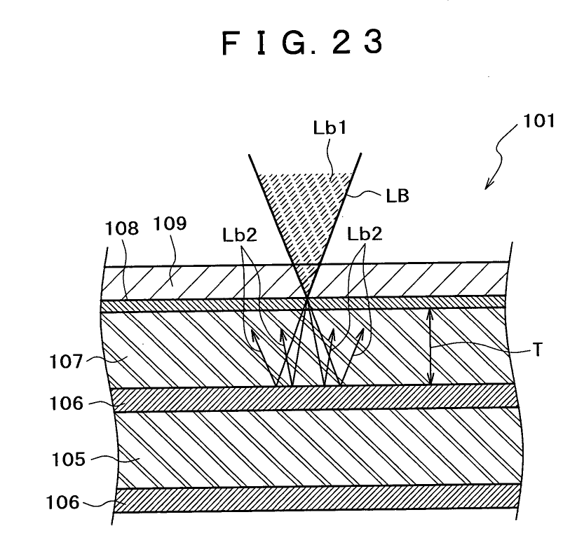

As seen in FIG. 23, the optical pickup 104 illuminates the laser beam LB on the small-size optical disk medium 101 from the protective film 109 side through an objective lens 104a. The laser beam LB having passed through the protective film 109 is reflected by the reflecting film 108 and returns to the optical pickup 104. The signals recorded on the reflecting film 108 can be read from a variation of the reflected light amount from the pits of the data recording layer 107. This is based on the same principle as that of a CD or a DVD.

The small-size optical disk medium 101 of the present invention has a characteristic that it itself is attracted to a magnet because the disk substrate is formed as the magnetic metal substrate 105. In a conventional optical disk medium, for example, in a mini disk (MD), it is necessary to adhere a metal piece called hub for being attracted to a magnet to the disk, while, in a CD or a DVD, a mechanism for fixing the disk such as a disk clamper is required. However, according to the present invention, a hub for attraction to a magnet, a disk clamper and so forth are not required, but the small-size optical disk medium 101 can be attracted by itself to the disk receiving face 103a of the turntable 103 by the magnetic force MF of the turntable 103.

In particular, the disk receiving face 103a of the turntable 103 made of a magnetic substance is magnetized at a suitable position thereof such that the N pole and the S pole are directed in the upward and downward directions so as to form the turntable 103 as a magnet. As a result, since the metal substrate 105 of the small-size optical disk medium 101 is attracted to the turntable 103 side by the magnetic force MF of the magnet of the turntable 103, the small-size optical disk medium 101 can be attracted horizontally on (parallelly to) the disk receiving face 103a of the turntable 103.

Thereupon, since the entire metal substrate 105 of the small-size optical disk medium 101 is attracted parallelly on the disk receiving face 103a of the turntable 103, warping of the small-size optical disk medium 101 is corrected thereby to improve the flatness of the overall small-size optical disk medium 101 significantly. Accordingly, when the laser beam LB is illuminated on the data recording layer 107 from the optical pickup 104 to read the reflected light, the focusing error can be reduced and reading of data can be performed always with a high degree of accuracy.

Further, since the metal substrate 105 is used as the optical disk substrate, the rigidity of the entire small-size optical disk medium 101 is raised when compared with a conventional optical disk medium wherein the disk substrate is made of polycarbonate (PC) like ordinary CDs and DVDs. This gives rise to an advantage that, where the disk rigidities are equal, the thickness of the entire small-size optical disk medium 101 can be reduced.

When the optical pickup 104 is used for signal reproduction, it is desirable to read only light reflected from the reflecting film 108. However, since the reflecting film 108 has a partial light passing property, the light having passed through the reflecting film 108 generates unnecessary reflected light at the picture-character layer 106.

Therefore, in the present invention, the thickness T (=distance between the picture-character layer 106 and the reflecting film 108) of the transparent resin layer (data recording layer 107) is made comparatively great to reduce unnecessary reflected light (refer to FIG. 23). The laser beam LB focused on the reflecting film 108 is thereafter dispersed, and the light component thereof having passed through the data recording layer 107 is projected on the picture-character layer 106 as a spot of a diameter which increases as the thickness of the transparent resin layer (data recording layer 107) increases. Therefore, the amount of unnecessary reflected light Lb2 reflected by the picture-character layer 106 which leaks into necessary reflected light Lb1 reflected by the reflecting film 108 can be reduced, and the degree of reading accuracy of data can be improved significantly.

If a two-layer recording disk used actually as a DVD or the like is described as an example, then reproduction is permitted where the distance between the first and second layers of the reflecting film is 20 μm. It is proved from actual results that, if a distance of at least 20 μm is provided, then even if some unnecessary reflected light from a different layer exists, the system operates normally. By the condition that the reflecting film 108 is formed as a reflecting film having a partial light passing property and the condition that the transparent resin layer (data recording layer 107) is formed with an increased thickness (equal to or more than 20 μm) to a level with which unnecessary reflected light Lb2 from the picture-character layer 106 does not matter, it becomes possible to insert a print of a picture or a character also on the signal recording face side of the disk. According to the related art, although printing on the rear face with respect to the signal recording face is possible, it is impossible to insert a print on the signal recording face side.

The small-size optical disk medium 101 of the present invention is characterized also in that, since the disk surface is covered with the protective film 109 as a protective layer, the disk surface is free from convex and concave shapes and can be formed as a flat face and further in that the small-size optical disk medium 101 does not have a center hole (hole at the center of the disk) as seen from FIG. 20A which shows the disk fully. A conventional optical disk medium essentially requires a center hole used for centering when the disk is fixed to a spindle motor.

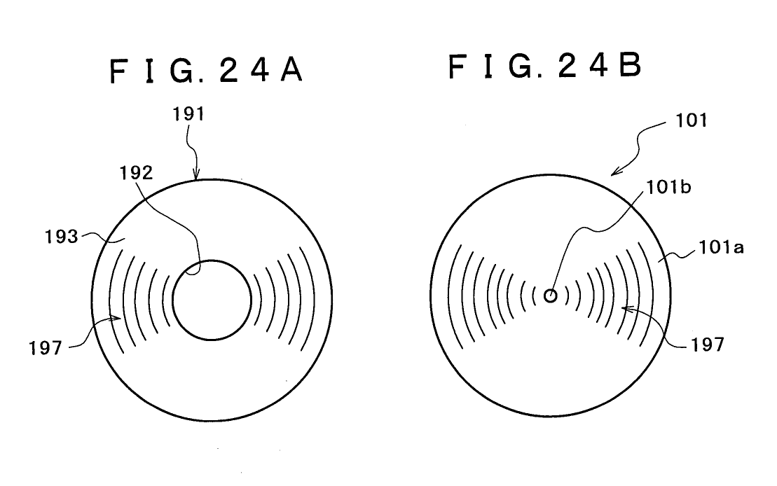

However, the small-size optical disk medium 101 of the present invention has a structure of the turntable 103 of the spindle motor 102 as hereinafter described so that the small-size optical disk medium 101 can be centered even if it does not have a center hole. Further, since the center hole is eliminated, the data recording layer 107 can be expanded by a great amount to a disk central portion 101b, and as a result, the recording capacity of the small-size optical disk medium 101 can be increased. In particular, FIG. 24A shows a popular optical disk medium 191 having a center hole perforated therein like a CD or a DVD. Since the optical disk medium 191 has a center hole 192 perforated at the center of the disk, the diameter of the inner circumference side of a data recording area 197 extending from a disk outer circumferential portion 193 to an inner circumferential portion of the disk cannot be reduced. Consequently, the optical disk medium 191 has a limitation to the increase of the recording capacity.

In contrast, with the small-size optical disk medium 101 of the present invention, since a center hole is not perforated at the center of the disk as seen in FIG. 24B, the data recording layer 107 can be expanded by a great amount to the disk center side such that it ranges from a disk outer circumferential portion 101a to the position of a diameter of approximately 0.5 mm of the disk central portion 10b. Further, in a conventional optical disk apparatus, since usually the data recording face of a small-size optical disk medium 101 rotated by the turntable 103 is directed downwardly and data is read from the data recording face by means of the optical pickup from the lower side of the small-size optical disk medium 101, if it is tried to decrease the diameter of the inner side of the center hole 192, then the optical pickup comes to interfere with the spindle motor. Also this provides a limitation to expansion of the recording capacity.

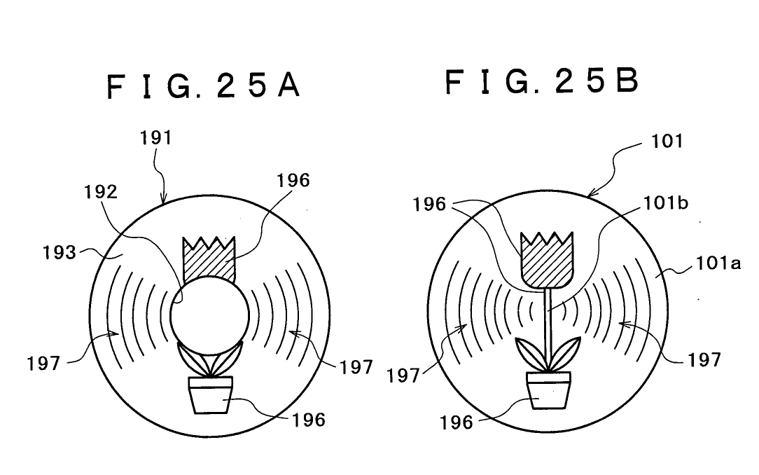

In contrast, in the optical disk apparatus of the present invention, since the spindle motor 102 and the optical pickup 104 are disposed on the opposite sides to each other across the small-size optical disk medium 101 as described hereinabove with reference to FIG. 26, even if the optical pickup 104 accesses the inner circumference side of the disk, the optical pickup 104 and the spindle motor 102 do not interfere with each other. Accordingly, also from the fact that the small-size optical disk medium 101 does not have a center hole and the fact that the optical pickup 104 can access up to the disk central portion 101b of the small-size optical disk medium 101 without interfering with the spindle motor 102 at all, the data recording layer 107 can be expanded to achieve increase of the recording capacity. FIG. 25A shows another popular optical disk medium 191 having a center hole perforated therein like a CD or a DVD. With the optical disk medium 191 shown in FIG. 25A, a picture-character layer 196 formed by drawing or printing of a picture, a character or the like is limited significantly by the center hole 192 perforated at the center of the disk. Consequently, it is impossible to make the most of the overall occupation area of the disk including the center hole 192 portion to display a picture, a character or the like in a large size and efficiently.

In contrast, with the small-size optical disk medium 101 of the present invention, since it does not have a center hole as shown in FIG. 25B, the picture-character layer 106 including the disk central portion 101b of the small-size optical disk medium 101 can be formed over a wide range. Accordingly, such a display as a picture or a character is not limited at all by the center hole, and a picture, a character or the like can be displayed efficiently in a large size and the fine appearance, commodity value and so forth of the optical disk medium can be enhanced significantly.

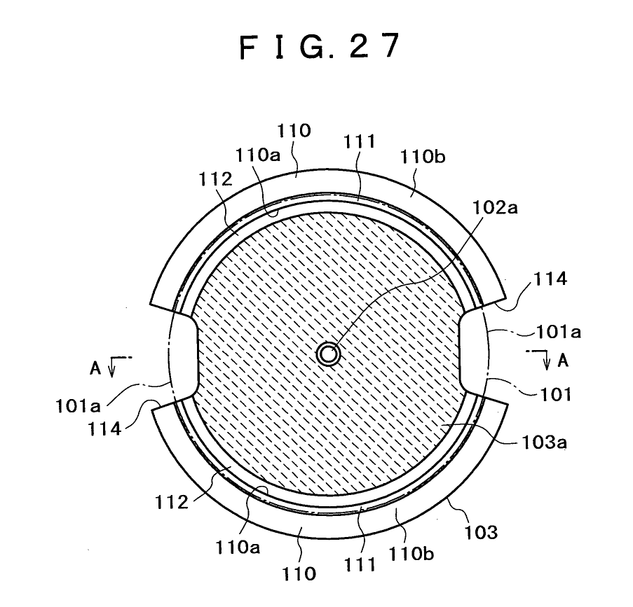

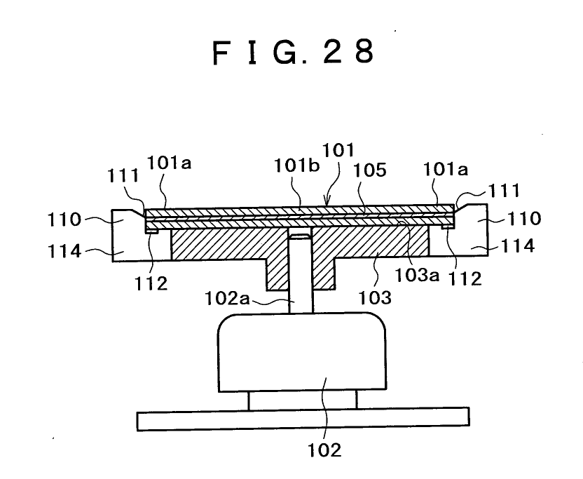

Now, the turntable 103 very suitable for the small-size optical disk medium of the present invention is described with reference to FIGS. 27 and 28. The turntable 103 of the present invention is formed as a unitary member from a magnet (bonded magnet, sintered magnet or the like) and is magnetized itself such that the N pole and the S pole are directed in upward and downward directions to exert magnetic force MF. The turntable 103 is characterized also in that it has an outer diameter greater than that of the small-size optical disk medium 101 and a cylindrical rib 110 for centering the small-size optical disk medium 101 is formed integrally and concentrically on the outer periphery of the disk receiving face 103a. As shown in FIG. 26, the small-size optical disk medium 101 is positioned such that the outer diameter thereof coincides with the inner diameter of the rib 110 and is attracted to the disk receiving face 103a by the magnetic force MF. The outer diameter of the small-size optical disk medium 101 and the inner diameter of the rib 110 are designed such that a gap of approximately 100 μm may be left therebetween taking part tolerances of them into consideration.

Also by the centering method, the centering accuracy within ±100 μm can be achieved, and thus, the small-size optical disk medium 101 can be centered with a degree of accuracy equal to that achieved by a conventional centering method which relies upon a center hole. The rib 110 plays a role also as a stopper for preventing the small-size optical disk medium 101 from escaping in a circumferential direction during rotation of the small-size optical disk medium 101. This method allows even the small-size optical disk medium 101 having no center hole to be centered on the turntable 103 with a degree of accuracy substantially equal to that achieved by the conventional method.

Further, the turntable 103 is a chamfered face 111 at a corner portion between an inner circumferential face 110a and an upper face 110b of the rib 110 so that, when the small-size optical disk medium 101 is inserted into the inside of the rib 110 so as to be attracted to (mounted on) the disk receiving face 103a, the chamfered face 111 may guide the outer periphery of the small-size optical disk medium 101 to introduce the small-size optical disk medium 101 smoothly into the inside of the rib 110. Accordingly, a mounting operation of the small-size optical disk medium 101 on the disk receiving face 103a of the turntable 103 can be performed smoothly.

It is to be noted that the height of the rib 110 is smaller than the thickness of the small-size optical disk medium 101. In order to assure good operability when the small-size optical disk medium 101 is mounted on or removed from the turntable 103, the optical pickup 104 is moved to the outer side with respect to the outermost periphery of the disk. Thereupon, if the height of the rib 110 is greater than the thickness of the disk, then there is the possibility that, when a portion of the optical pickup 104 such as the objective lens 104a which is positioned closely to the small-size optical disk medium 101 moves in a radial direction of the turntable 103, it may be caught by the rib 110. If the height of the rib 110 is smaller than the thickness of the small-size optical disk medium 101, then there is no possibility that the portion may be caught.

Further, one or a plurality of cutaway portions 114 are formed on the outer periphery of the turntable 103. The cutaway portions 114 are portions into which fingers of a user are inserted to pick the small-size optical disk medium 101 in order to mount or remove the small-size optical disk medium 101 on or from the turntable 103. If the turntable 103 has no such cutaway portion 114, then the rib 110 of the turntable 103 makes an obstacle and makes it difficult particularly for the user to remove the small-size optical disk medium 101.

As described hereinabove, the small-size optical disk medium 101 is attracted to the turntable 103 by the magnetic force MF over a wide range from the inner periphery to the outer periphery thereof. With the method of the invention, even if the small-size optical disk medium 101 should have some warping, it is forced to follow the disk receiving face 103a having a high rigidity by the attracting force of the magnetic force MF. This indicates that, if the disk receiving face 103a has a good flatness, then even if the small-size optical disk medium 101 has a comparatively great amount of warping, when it is actually used, it is corrected to a state wherein it has a good flatness. Accordingly, if the flatness of the disk receiving face 103a is improved when compared with the specifications regarding the out-of-plane deflection or the flatness prescribed by the standards for the small-size optical disk medium 101, then when it is actually used, there is an effect that the amount of warping of the small-size optical disk medium 101 is decreased. In other words, the standards for the warping of the small-size optical disk medium 101 can be moderated.

Referring also to FIG. 27 to FIG. 29, the turntable 103 has an annular recess or groove 112 for providing a relief in the heightwise direction along an outer circumferential portion of the disk receiving face 103a.

The recess 112 is provided as a relief for a portion of the small-size optical disk medium 101 within a range of 1 to 2 mm from the outer peripheral end of the small-size optical disk medium 101 because the portion has a thickness greater by approximately 50 μm or less. In particular, in the small-size optical disk medium 101, the protective film 109 is formed by spin coating as described hereinabove with reference to FIG. 18. While the spin coating forms a film using centrifugal force, there is a nature that the UV resin material or the like accumulates only at the outermost peripheral portion of the small-size optical disk medium 101 because of the surface tension thereby to form a swollen portion 115 at which the film has an increased thickness. If the recess 112 for a relief is not provided on the turntable 103, then when the small-size optical disk medium 101 is attracted to the disk receiving face 103a of the turntable 103, there is the possibility that the swollen portion 115 may ride on (interfere with) the disk receiving face 103a thereby to rather increase the warping of the small-size optical disk medium 101.

However, as described hereinabove with reference to FIG. 19, the small-size optical disk medium 101 of the present invention is produced such that, when six small-size optical disk medium working regions 152 of a large-size metal substrate are pressed at a time by press work to cut out six small-size optical disk media from the large-size metal substrate, the small-size optical disk media are cut out with a diameter D4 (=30 mm) sufficiently smaller than the diameter D3 (=53 mm) of the small-size optical disk medium working regions 152.

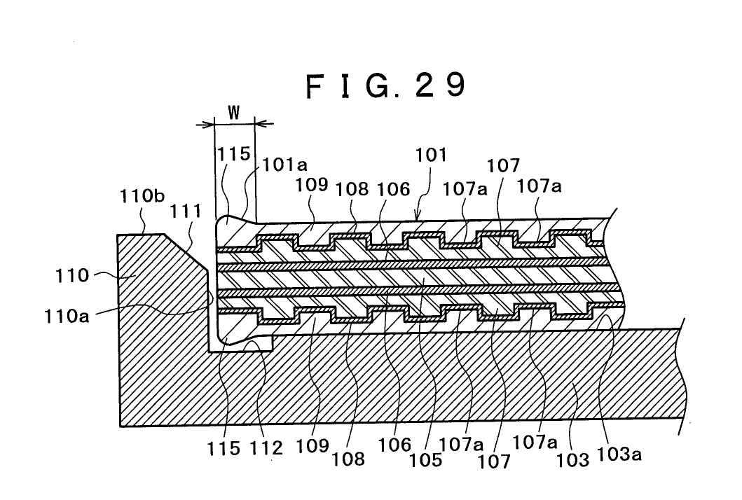

In other words, since the small-size optical disk media 101 are cut out by press work from the small-size optical disk medium working regions 152 in such a manner that the small-size optical disk media 101 may not include the swollen portions 115 of the protective films 109 appearing at outermost circumferential portions of the small-size optical disk medium working regions 152, such a swollen portion 115 of a protective film 109 as shown in FIG. 29 does not appear (exist) at the outermost circumferential portion of the small-size optical disk medium 101 produced in accordance with the present invention. Accordingly, the turntable 103 with which the small-size optical disk medium 101 of the present invention is used is characterized in that, even if the annular recess (relief) 112 is not formed on an outer circumferential portion of the disk receiving face 103a thereof, the small-size optical disk medium 101 can be placed parallelly in a closely contacting relationship with a high degree of accuracy on the disk receiving face 103a.

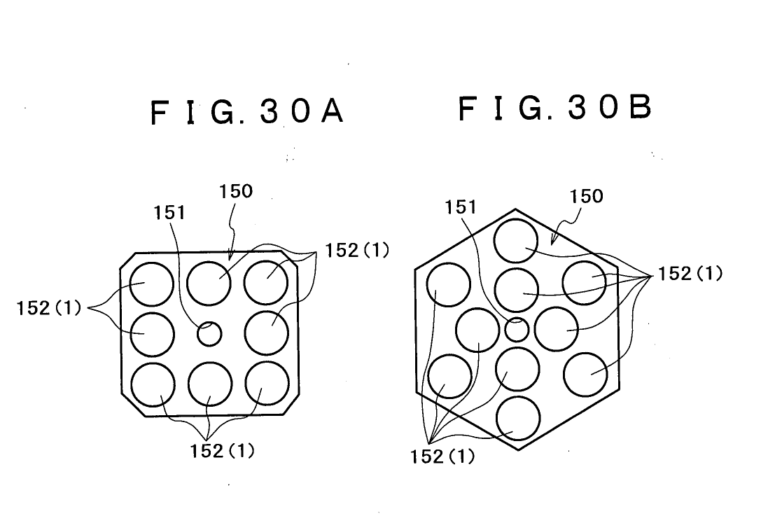

It is to be noted that, as described hereinabove, the large-size metal substrate 50 need not necessarily have a shape of a disk but may have such a polygonal shape as shown, for example, in FIG. 30A or 30B. Also the plural small-size optical disk medium working regions 152 disposed in the large-size metal substrate 150 need not necessarily be disposed in equally spaced ring-like arrangement but may be disposed in different arrangement as seen in FIG. 30A or 30B.

Further, for example, upon press work illustrated in FIG. 19, it is possible to form center holes of optical disk media at a time.

The present invention is not limited to the embodiments described hereinabove but allows various effective modifications based on the technical scope thereof. The optical disk medium of the present invention is not limited to an optical disk on and/or from which data is recorded and/or reproduced optically but can be applied also to a magneto-optical disk on and/or from which data is recorded and/or reproduced magneto-optically.

Further, although the optical disk medium production method of the present invention described above is applied to an optical disk medium in the form of a small-size optical disk medium having a diameter of 3 cm, the present invention can be applied also to a production method of an optical disk medium having a diameter equal to or greater than 12 cm like ordinary CDs and DVDs.

While a preferred embodiment of the present invention has been described using specific terms, such description is for illustrative purposes only, and it is to be understood that changes and variations may be made without departing from the spirit or scope of the following claims.

1. An optical disk medium, comprising:
a metal substrate made of a magnetic substance and forming a disk for correcting a flatness of said optical disk medium by magnetic attraction to a metal turntable.

2. The optical disk medium according to claim 1, further comprising a picture-character layer formed on at least one of the opposite faces of said metal substrate and having thereon a picture or a character.

3. The optical disk medium according to claim 1, further comprising a first picture-character layer formed on one face of said metal substrate and
a second picture-character layer formed on the other face of said metal substrate.

4. The optical disk medium according to claim 1, further comprising a data recording layer formed on said metal substrate.

5. The optical disk medium according to claim 4, further comprising a picture-character layer formed on at least one of the opposite faces of said metal substrate and thereon a picture or a character that can be visually observed through said data recording layer.

6. The optical disk medium according to claim 4, further comprising a first picture-character layer formed on one face of said disk and being capable of being visually observed through said data recording layer of said disk and
a second picture-character layer formed on the other face of said disk.

7. The optical disk medium according to claim 4, further comprising a reflecting film formed as an overlying layer of said data recording layer and capable of passing a portion of a light beam.

8. The optical disk medium according to claim 6, further comprising a protective layer formed on said picture-character layer is provided and being capable of passing light.

9. The optical disk medium according to claim 1, wherein said disk has an annular rib formed on at least one of the opposite faces of said disk along one of an outer circumferential portion and an inner circumferential portion of said disk.

10. An optical disk medium, comprising:
a metal substrate made of a magnetic substance and forming a disk for correcting a flatness of said optical disk medium by magnetic attraction to a metal turntable;
a data recording layer formed on said metal substrate; and
a picture-character layer formed on at least one of the opposite faces of said metal substrate and having thereon a picture or a character that can be visually observed through said data recording layer.

11. The optical disk medium according to claim 10, further comprising a reflecting film capable of passing a portion of a light beam and being formed as an overlying layer of said data recording layer.

12. The optical disk medium according to claim 11, wherein a distance between said reflecting film and said picture-character layer is set to substantially 20 μm or more.

13. The optical disk medium according to claim 10, further comprising a protective layer formed on a surface of said disk on which said picture-character layer is formed and being capable of passing a light beam.

14. The optical disk medium according to claim 10, wherein said disk has an annular rib formed on at least one of the opposite faces of said disk along one of an outer circumferential portion and an inner circumferential portion of said disk.

15. A turntable having a disk receiving face for receiving an optical disk medium, the optical disk medium including a metal substrate made of a magnetic substance and forming a disk for correcting the flatness of said optical disk medium by being magnetically attracted to said disk receiving face.

16. The turntable according to claim 15, wherein the optical disk medium is attracted to said disk receiving face of said turntable by magnetic force generated from a magnetized portion of said turntable.

17. The turntable according to claim 15, wherein said turntable is made of metal, and said optical disk medium is attracted to said disk receiving face of said turntable by magnetic force generated from a magnetized portion of said metal substrate.

18. The turntable according to claim 15, wherein said turntable has a cutaway portion formed on an outer periphery of said turntable so as a to allow part of an outer periphery of the optical disk medium to be grasped to remove or mount the optical disk medium relative to said turntable.

19. The turntable according to claim 15, wherein said disk receiving face of said turntable has a degree of flatness higher than a degree of flatness of the optical disk medium.

20. The turntable according to claim 15, wherein an annular recess is formed along an outer circumferential portion of said disk receiving face of said turntable.

21. An optical disk apparatus, comprising:
a turntable having a disk receiving face for receiving an optical disk medium, the optical disk medium including a metal substrate made of a magnetic substance and forming a disk for correcting the flatness of said optical medium disk by being magnetically attracted to said disk receiving face;
a spindle motor for rotating said turntable; and
an optical pickup for recording and/or reproducing data on and/or from the optical disk medium being rotated on said turntable.

22. An optical disk medium, comprising:
a disk having no center hole; and
a picture-character layer formed in a wide area from an outer periphery to a portion within a radius of 0.5 mm to the center of said disk and having thereon a picture or a character.

23. The optical disk medium according to claim 22, wherein said disk has a uniform thickness over an overall area of said disk except at least at an outer peripheral portion of said disk.

24. The optical disk medium according to claim 22, further comprising a picture-character layer formed on at least one of the opposite faces of said metal substrate, and a protective layer formed on the surface of said disk on which said picture-character layer is provided and being capable of passing light.

25. The optical disk medium according to claim 22, wherein said disk has an annular rib formed on at least one of the opposite faces of said disk along one of an outer circumferential portion and an inner circumferential portion of said disk.

26. An optical disk medium, comprising:
a disk having no center hole; and
a data recording layer formed in an area from an outer periphery to a portion within a radius of 0.5 mm from a center of said disk.

27. The optical disk medium according to claim 26, wherein said disk has a uniform thickness over an overall area of said disk except at least at an outer peripheral portion of said disk.

28. The optical disk medium according to claim 26, further comprising a picture-character layer formed on at least one of the opposite faces of said metal substrate, and a protective layer formed on the surface of said disk on which said picture-character layer is provided and capable of passing light.

29. The optical disk medium according to claim 26, wherein said disk has an annular rib formed on at least one of the opposite faces of said disk along at least one of an outer circumferential portion and an inner circumferential portion of said disk.

30. An optical disk medium, comprising:
a disk having no center hole;
a data recording layer formed in an area from an outer periphery to a portion within a radius of 0.5 mm from a center of said disk; and
a printed layer formed in an area from an outer periphery to a portion within a radius of 0.5 mm from the center of said disk and having thereon a picture or a character so as to be visually observed through said data recording layer.

31. The optical disk medium according to claim 30, wherein said disk has a uniform thickness over an overall area of said disk except at least at an outer peripheral portion of said disk.

32. The optical disk medium according to claim 30, further comprising a picture-character layer formed on at least one of the opposite faces of said metal substrate, and a protective layer formed on the surface of said disk on which said picture-character layer is provided and being capable of passing light.

33. The optical disk medium according to claim 30, wherein said disk has an annular rib formed on at least one of the opposite faces of said disk along one of an outer circumferential portion and an inner circumferential portion of said disk.

34. A turntable having a disk receiving face for receiving an optical disk medium, the optical disk medium including a disk having no center hole, and a picture-character layer formed in an area from an outer periphery to a portion within a radius of 0.5 mm from a center of said disk and having thereon a picture or a character, said turntable having a disk positioning rib formed along an outer periphery of said disk receiving face.

35. The turntable according to claim 34, wherein said disk positioning rib is chamfered along a corner between an inner circumferential face and an upper horizontal face of said disk positioning rib.

36. The turntable according to claim 34, wherein said disk positioning rib has a height less than a thickness of the optical disk medium.

37. The turntable according to claim 34, wherein said turntable has a cutaway portion formed on an outer periphery of said turntable so as to allow part of an outer periphery of the optical disk medium to be grasped to remove or mount the optical disk medium from or on said turntable.

38. A turntable having a disk receiving face for receiving an optical disk medium, the optical disk medium including a disk having no center hole, and a data recording layer formed in an area from an outer periphery to a portion within a radius of 0.5 mm from the center of said disk, said turntable having a disk positioning rib formed along an outer periphery of said disk receiving face.

39. The turntable according to claim 38, wherein said disk positioning rib is chamfered along a corner between an inner circumferential face and an upper horizontal face of said disk positioning rib.

40. The turntable according to claim 38, wherein said disk positioning rib has a height less than a thickness of the optical disk medium.

41. The turntable according to claim 38, wherein said turntable has a cutaway portion formed on an outer periphery of said turntable so as to allow part of an outer periphery of the optical disk medium to be grasped to remove or mount the optical disk medium from or on said turntable.

42. A turntable having a disk receiving face for receiving an optical disk medium, the optical disk medium including a disk having no center hole, a data recording layer formed in a wide area from an outer periphery to a portion within a radius of 0.5 mm from a center of said disk, and a printed layer formed in an area from an outer periphery to a portion within a radius of 0.5 mm to the center of said disk and having thereon a picture or a character so as to be visually observed through said data recording layer, said turntable having a disk positioning rib formed along an outer periphery of said disk receiving face.

43. The turntable according to claim 42, wherein said disk positioning rib is chamfered along a corner between an inner circumferential face and an upper horizontal face of said disk positioning rib.

44. The turntable according to claim 42, wherein said disk positioning rib has a height less than a thickness of the optical disk medium.

45. The turntable according to claim 42, wherein said turntable has a cutaway portion formed on an outer periphery of said turntable so as to allow part of an outer periphery of the optical disk medium to be grasped to remove or mount the optical disk medium from or on said turntable.

46. An optical disk apparatus, comprising:
a turntable having a disk receiving face for receiving an optical disk medium, the optical disk medium including a disk having no center hole, and a picture-character layer formed in a wide area from an outer periphery to a portion within a radius of 0.5 mm from a center of said disk and having thereon a picture or a character, said turntable having a disk positioning rib formed along an outer periphery of said disk receiving face;
a spindle motor for rotating said turntable; and
an optical pickup for recording and/or reproducing data on and/or from the optical disk medium being rotated by said turntable.

47. The optical disk apparatus according to claim 46, wherein said optical pickup records and/or reproduces data over a range of said optical disk medium from an outer periphery to the center.

48. An optical disk apparatus, comprising:
a turntable having a disk receiving face for receiving an optical disk medium, the optical disk medium including a disk having no center hole, and a data recording layer formed in an area from an outer periphery to a portion within a radius of 0.5 mm from a center of said disk, said turntable having a disk positioning rib formed along an outer periphery of said disk receiving face;
a spindle motor for rotating said turntable; and
an optical pickup for recording and/or reproducing data on and/or from the optical disk medium being rotated by said turntable.

49. The optical disk apparatus according to claim 48, wherein said optical pickup records and/or reproduces data over a range of said optical disk medium from an outer periphery to the center.

50. An optical disk apparatus, comprising:
a turntable having a disk receiving face for receiving an optical disk medium, the optical disk medium including a disk having no center hole, a data recording layer formed in an area from an outer periphery to a portion within a radius of 0.5 mm from a center of said disk, and a printed layer formed in an area from an outer periphery to a portion within a radius of 0.5 mm from the center of said disk and having thereon a picture or a character so as to be visually observed through said data recording layer, said turntable having a disk positioning rib formed along an outer periphery of said disk receiving face;
a spindle motor for rotating said turntable; and
an optical pickup for recording and/or reproducing data on and/or from the optical disk medium being rotated by said turntable.

51. The optical disk apparatus according to claim 50, wherein said optical pickup records and/or reproduces data over a range of said optical disk medium from an outer periphery to the center.

52. An optical disk medium production method for producing an optical disk medium wherein a data recording layer, a reflecting film, and a protective film are layered on at least one face of a metal substrate, comprising the steps of:
layering a data recording layer, a reflecting film, and a projective film at each of a plurality of locations of at least one face of a metal substrate to form a plurality of small-size, relative to a size of said metal substrate, optical disk media; and
punching out the small-size optical disk media from the large-size metal substrate.

53. The optical disk medium production method according to claim 52, wherein the metal substrate is rotated within a horizontal plane around a center hole formed therein.

54. The optical disk medium production method according to claim 53, wherein, when the metal substrate is rotated within the horizontal plane around the center hole, the metal substrate is positioned in the rotational direction by one of a positioning hole and a cutaway portion formed at a position proximate an outer periphery of the metal substrate.

55. The optical disk medium production method according to claim 54, wherein, when the metal substrate is rotated within the horizontal plane around the center hole, the metal substrate is rotationally balanced by at least one of a balancing hole and a cutaway portion formed at a position proximate the outer periphery of the metal substrate in an opposing relationship to the positioning hole.

56. The optical disk medium production method according to claim 53, wherein the protective film is formed by spin coating, while the metal substrate is rotated within the horizontal plane around the center hole.

57. The optical disk medium production method according to claim 56, wherein a plurality of small-size optical disk medium working regions for being worked at plural locations of at least one face of the metal substrate and being formed of the data recording layer, the reflecting film, and the protective layer are disposed in ring-like arrangement around the center of rotation of the metal substrate.

58. The optical disk medium production method according to claim 57, wherein the small-size optical disk medium working regions are punched simultaneously to produce the small-size optical disk media.

59. The optical disk medium production method according to claim 58, wherein the metal substrate has a diameter equal to or less than substantially 120 mm, and the small-size optical disk medium working regions have a diameter equal to or less than substantially 53 mm.

60. The optical disk medium production method according to claim 59, wherein, when the small-size optical disk medium working regions are worked at a time by press work to produce the small-size optical disk media, a region of each of the small-size optical disk medium working regions displaced by equal to or more than 2 mm to the inner side from the outermost peripheral position is worked by press work.

61. An optical disk medium production method for producing an optical disk medium wherein a picture-character layer on which one of a picture and a character is formed, a data recording layer, a reflecting film, and a protective film are layered on at least one face of a metal substrate, the production method comprising the steps of:
layering a picture-character layer, a data recording layer, a reflecting film, and a projective film at each of a plurality of locations of at least one face of a metal substrate to form a plurality of small-size, relative to a size of the metal substrate, optical disk media; and
punching out the small-size optical disk media from the large-size metal substrate.

62. The optical disk medium production method according to claim 61, wherein the metal substrate is rotated within a horizontal plane around a center hole.

63. The optical disk medium production method according to claim 62, wherein, when the metal substrate is rotated within the horizontal plane around the center hole, the metal substrate is positioned in the rotational direction by one by a positioning hole and a cutaway portion formed at a position proximate an outer periphery of the metal substrate.

64. The optical disk medium production method according to claim 63, wherein, when the metal substrate is rotated within the horizontal plane around the center hole, the metal substrate is rotationally balanced by at least one of a balancing and a cutaway portion formed at a position proximate of the outer periphery of the metal substrate in an opposing relationship to the positioning hole.

65. The optical disk medium production method according to claim 62, wherein the protective film is formed by spin coating, while the metal substrate is rotated within the horizontal plane around the center hole.

66. The optical disk medium production method according to claim 65, wherein a plurality of small-size optical disk medium working regions at plural locations of at least one face of the large-size metal substrate and being formed of the data recording layer, the reflecting film, and the protective layer are disposed in ring-like arrangement around the center of rotation of the metal substrate.

67. The optical disk medium production method according to claim 66, wherein the small-size optical disk medium working regions are punched to produce the small-size optical disk media.

68. The optical disk medium production method according to claim 67, wherein the metal substrate has a diameter equal to or less than substantially 120 mm, and the small-size optical disk medium working regions have a diameter equal to or less than substantially 53 mm.

69. The optical disk medium production method according to claim 68, wherein, when the small-size optical disk medium working regions are worked by press work to produce the small-size optical disk media, a region of each of the small-size optical disk medium working regions displaced by equal to or more than 2 mm to an inner side from an outermost peripheral position is worked by press work.

70. The optical disk medium production method according to claim 65, wherein a plurality of small-size optical disk medium working regions for being worked plural locations of at least one face of the metal substrate and being formed of the picture-character layer, the data recording layer, the reflecting film, and the protective layer are disposed in ring-like arrangement around the center of rotation of the metal substrate.

71. The optical disk medium production method according to claim 70, wherein the small-size optical disk medium working regions are punched to produce the small-size optical disk media.

72. The optical disk medium production method according to claim 71, wherein the metal substrate has a diameter equal to or less than substantially 120 mm, and the small-size optical disk medium working regions have a diameter equal to or less than substantially 53 mm.

73. The optical disk medium production method according to claim 72, wherein, when the small-size optical disk medium working regions are worked by press work to produce the small-size optical disk media, a region of each of the small-size optical disk medium working regions displaced by equal to or more than 2 mm to an inner side from an outermost peripheral position is worked by press work.
